(19) United States
(12) Patent Application Publication
(10) Pub. No.: US 2025/0324365 A1
(43) Pub. Date: Oct. 16, 2025

(54) NODE, WIRELESS DEVICE, AND METHODS PERFORMED THEREBY, FOR HANDLING A TIME GAP

(71) Applicant: Telefonaktiebolaget LM Ericsson (publ), Stockholm (SE)

(72) Inventors: Andreas HÖGLUND, Solna (SE); Tuomas TIRRONEN, Helsinki (FI)

(21) Appl. No.: 18/712,853

(22) PCT Filed: Nov. 25, 2022
(86) PCT No.: PCT/SE2022/051100

§ 371 Date: Sep. 12, 2024

Related U.S. Application Data
(60) Provisional application No. 63/264,587, filed on Nov. 26, 2021.

(51) Int. Cl. H04W 52/02; H04W 76/28

(52) U.S. Cl. CPC H04W 52/0235; H04W 52/028; H04W 76/28

(57) ABSTRACT

A method by a node, for handling a time gap. The node operates in a wireless communications network. The node determines a respective duration of a time gap. The time gap is between a transmission of one or more respective signals to wake-up one or more wireless devices operating in the wireless communications network and a beginning of one or more respective paging occasions. The determining is based on a condition. The condition is independent of whether or not the one or more wireless devices use discontinuous reception or extended discontinuous reception. The node initiates transmission of the one or more respective signals to the one or more wireless devices based on the determined respective duration.

### CROSS-REFERENCE TO RELATED APPLICATIONS

This application is a Submission Under 35 U.S.C. § 371 for U.S. National Stage Patent Application of International Application No. PCT/SE2022/051100, filed Nov. 25, 2022 entitled “NODE, WIRELESS DEVICE, AND METHODS PERFORMED THEREBY, FOR HANDLING A TIME GAP,” which claims priority to U.S. Provisional Application No. 63/264,587, filed Nov. 26, 2021, the entireties of both of which are incorporated herein by reference.

### TECHNICAL FIELD

The present disclosure relates generally to a node, and methods performed thereby, for handling a time gap. The present disclosure also relates generally to a wireless device and methods performed thereby for handling the time gap.

### BACKGROUND

Nodes within a communications network may be wireless devices such as e.g., User Equipments (UEs), stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone, and/or between a wireless device and a server via a Radio Access Network (RAN), and possibly one or more core networks, comprised within the communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

Nodes may also be network nodes, such as radio network nodes, e.g., Transmission Points (TP). The communications network covers a geographical area which may be divided into cell areas, each cell area being served by a network node such as a Base Station (BS), e.g. a Radio Base Station (RBS), which sometimes may be referred to as e.g., gNB, evolved Node B (“eNB”), “eNodeB”, “NodeB”, “B node”, or Base Transceiver Station (BTS), depending on the technology and terminology used. The base stations may be of different classes such as e.g.

Wide Area Base Stations, Medium Range Base Stations, Local Area Base Stations and Home Base Stations, based on transmission power and thereby also cell size. A cell is the geographical area where radio coverage is provided by the base station at a base station site. One base station, situated on the base station site, may serve one or several cells. Further, each base station may support one or several communication technologies. The communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The so-called 5G system, from a radio perspective started to be standardized in 3GPP, and the so-called New Radio (NR) is the name for the radio interface. NR architecture is being discussed in 3GPP. In the current concept, gNB denotes an NR BS, where one NR BS may correspond to one or more transmission/reception points. The expression Uplink (UL) may be used for the transmission path in the opposite direction i.e., from the wireless device to the base station.

The Fifth Generation (5G) Packet Core Network may be referred to as Next Generation (NG) Core Network, abbreviated as NG-CN, NGC or 5G CN.

### Internet of Things (IoT)

The Internet of Things (IoT) may be understood as an internetworking of communication devices, e.g., physical devices, vehicles, which may also be referred to as “connected devices” and “smart devices”, buildings and other items-embedded with electronics, software, sensors, actuators, and network connectivity that may enable these objects to collect and exchange data. The IoT may allow objects to be sensed and/or controlled remotely across an existing network infrastructure.

“Things,” in the IoT sense, may refer to a wide variety of devices such as heart monitoring implants, biochip transponders on farm animals, electric clams in coastal waters, automobiles with built-in sensors, DNA analysis devices for environmental/food/pathogen monitoring, or field operation devices that may assist firefighters in search and rescue operations, home automation devices such as the control and automation of lighting, heating, e.g., a “smart” thermostat, ventilation, air conditioning, and appliances such as washer, dryers, ovens, refrigerators or freezers that may use telecommunications for remote monitoring. These devices may collect data with the help of various existing technologies and then autonomously flow the data between other devices.

It is expected that in a near future, the population of IoT devices will be very large. Various predictions exist, among which one assumes that there will be >60000 devices per square kilometer, and another assumes that there will be 1000000 devices per square kilometer. A large fraction of these devices is expected to be stationary, e.g., gas and electricity meters, vending machines, etc.

### Machine Type Communication (MTC)

Machine Type Communication (MTC) has in recent years, especially in the context of the Internet of Things (IoT), shown to be a growing segment for cellular technologies. An MTC device may be a communication device, typically a wireless communication device or simply user equipment, that is a self and/or automatically controlled unattended machine and that is typically not associated with an active human user in order to generate data traffic. An MTC device may be typically simpler, and typically associated with a more specific application or purpose, than, and in contrast to, a conventional mobile phone or smart phone. MTC involves communication in a wireless communication network to and/or from MTC devices, which communication typically may be of quite different nature and with other requirements than communication associated with e.g. conventional mobile phones and smart phones. In the context of and growth of the IoT, it is evident that MTC traffic will be increasing and thus needs to be increasingly supported in wireless communication systems.

Wake-up receiver (WUR), sometimes also referred to as ‘wake-up radio’, may be understood to relate to enabling a low power receiver in UEs, which, in case of the detection of a ‘Wake-up signal’ (WUS), may wake up the main, e.g., baseband/higher power, receiver to detect an incoming message, typically paging, e.g., the Physical Downlink Control Channel (PDCCH) in paging occasions (POs), scheduling the paging message on the Physical Downlink Shared Channel (PDSCH). The main benefit may be understood to be lower energy consumption and longer device battery life, or at a fixed energy consumption, the downlink latency may be reduced, shorter Discontinued Reception (DRX)/duty-cycles, and more frequent checks for incoming transmissions.

FIG. 1 is a schematic diagram illustrating location of a WUS and the paging occasion to which it is associated. In FIG. 1, white blocks indicate possible WUS, and PO positions, whereas the black boxes indicate actual WUS and PO positions.

### WUS for NB-IoT and LTE-M

### Release 15

In Rel-15, WUS was specified for NarrowBand IoT (NB-IoT) and Long Term Evolution for Machines (LTE-M). The main motivation was UE energy consumption reduction since, with the coverage enhancement, PDCCH may be repeated very many times and the WUS may be relatively much shorter and hence may require less reception time for the UE. The logic may be understood to be that a UE may check for a WUS a certain time before its PO, and only if a WUS is detected, the UE may continue to check for PDCCH in the PO, and if not, which is most of the time, the UE may go back to a sleep state to conserve energy. Due to the coverage enhancements, the WUS may be of variable length depending on the coverage of the UE, see FIG. 2.

FIG. 2 is a schematic diagram illustrating WUS for NB-IoT and LTE-M. As depicted in in FIG. 2, where the horizontal axis represents time, the WUS may have a duration, which may be a fraction of a configured maximum WUS duration. Between the end of the configured maximum WUS duration and the beginning of the associated paging occasion (PO) there may be a gap. A gap may be understood as a time offset between the WUS monitoring occasion and the paging occasion. A gap may also be referred to as an offset.

A WUS may be based on the transmission of a short signal that may indicate to the UE that it may need to continue to decode the Downlink (DL) control channel e.g., the full Narrowband PDCCH (NPDCCH) for NB-IoT. If such signal is absent, e.g., in Discontinuous Transmission (DTX) that is, if the UE does not detect it, then the UE may go back to sleep without decoding the DL control channel. The decoding time for a WUS may be considerably shorter than that of the full NPDCCH since it may only need to contain one bit of information, whereas the NPDCCH may contain up to 35 bits of information. This, in turn, may be understood to reduce UE power consumption and lead to longer UE battery life. The WUS would be transmitted only when there may be paging for the UE. But if there is no paging for the UE, then the WUS may be understood to not be transmitted, implying a discontinuous transmission (DTX) and the UE may go back to sleep e.g., upon detecting DTX instead of WUS. This is illustrated in FIG. 1, where white blocks indicate possible WUS, and PO positions whereas the black boxes indicate actual WUS and PO positions.

The specification of Rel-15 WUS is spread out over several parts of the LTE 36-series standard, e.g., 36.211, 36.213, 36.304 and 36.331.

A UE may report its WUS capability to the network, and WUS gap capability, that is, the minimum time required for the UE to start up its main receiver see below. Further WUS information was added in the specification to the paging message/request from Mobility Management Entity (MME) to an eNB, see UE radio paging capabilities. An eNB may use WUS for paging the UE if and only if (IFF) 1) WUS is enabled in the cell, e.g., WUS-Config may be present in System Information (SI), and 2) the UE may support WUS according to the wakeUpSignal-r15 UE capability, see also the description of WUS gap below.

WUS was introduced for both LTE-M and NB-IoT with support for both DRX and extended DRX (eDRX), the former with a 1-to-1 mapping between the WUS and the PO, and for the latter in an addition with the possible configuration of 1-to-N, many, POs. An eNB may configure one WUS gap for UEs using DRX, and another one for UEs using eDRX, see e.g., TS 36.331, version 16.6.0, examples are given for NB-IoT, LTE-M is similar:

WUS-Config-NB information element

| | |
|---|---|
| WUS-Config-NB-r15 ::= | SEQUENCE { |
| maxDurationFactor-r15 | WUS-MaxDurationFactor-NB-r15, |
| numPOs-r15 | ENUMERATED {n1, n2, n4} DEFAULT n1, |
| numDRX-CyclesRelaxed-r15 | ENUMERATED {n1, n2, n4, n8}, |
| timeOffsetDRX-r15 | ENUMERATED {ms40, ms80, ms160, |

ms240},

| | |
|---|---|
| timeOffset-eDRX-Short-r15 | ENUMERATED {ms40, ms80, ms160, |

ms240},

| | |
|---|---|
| timeOffset-eDRX-Long-r15 | ENUMERATED {ms1000, ms2000} |

```
  OPTIONAL, -- Need OP
  ...
}
```

| | |
|---|---|
| WUS-ConfigPerCarrier-NB-r15 ::= | SEQUENCE { |
| maxDurationFactor-r15 | WUS-MaxDurationFactor-NB-r15 |

}

| | |
|---|---|
| WUS-MaxDurationFactor-NB-r15 ::= | ENUMERATED {one128th, |

one64th, one32th, one16th,

oneEighth, oneQuarter,

oneHalf}

WUS-Config-NB field descriptions

timeOffsetDRX
When DRX is used, non-zero gap from the end of the configured
maximum WUS duration to the associated PO, see TS 36.304 [4],
clause 7.4 and TS 36.211 [21]. In milliseconds. Value ms40
corresponds to 40 ms, value ms80 corresponds to 80 ms and so on.
timeOffset-eDRX-Short
When eDRX is used, the short non-zero gap from the end of the
configured maximum WUS duration to the associated PO, see TS 36.304
[4], clause 7.4 and TS 36.211 [21]. In milliseconds.
Value ms40 corresponds to 40 ms, value ms80 corresponds to 80
ms and so on.
E-UTRAN configures timeOffset-eDRX-Short to a value longer
than or equal to timeOffsetDRX.
timeOffset-eDRX-Long
When eDRX is used, the long non-zero gap from the end of the
configured maximum WUS duration to the associated PO, see TS
36.304 [4], clause 7.4 and TS 36.211 [21]. In milliseconds.
Value ms1000 corresponds to 1000 ms, value ms2000 corresponds
to 2000 ms.

The UE capabilities may also indicate the minimum WUS gaps required for the UE to be able to decode PDCCH in the associated PO, for DRX and eDRX, respectively, see TS 36.331, version 16.6.0:

UE-RadioPagingInfo-NB information element

| UE-RadioPagingInfo-NB-r13 ::= | SEQUENCE { | |
|---|---|---|
| ue-Category-NB-r13 | ENUMERATED {nb1} | OPTIONAL, |

...,

| | |
|---|---|
| [[ multiCarrierPaging-r14 | ENUMERATED {true} |

```
  OPTIONAL
  ]],
```

| | | |
|---|---|---|
| [[ | mixedOperationMode-r15 | ENUMERATED {supported} |

OPTIONAL,

| | | |
|---|---|---|
| wakeUpSignal-r15 | ENUMERATED {true} | OPTIONAL, |

| | |
|---|---|
| wakeUpSignalMinGap-eDRX-r15 | ENUMERATED {ms40, ms240, |

ms1000, ms2000} OPTIONAL,

| | |
|---|---|
| multiCarrierPagingTDD-r15 | ENUMERATED {true} |

```
  OPTIONAL
  ]],
```

| | | |
|---|---|---|
| [[ | ue-Category-NB-r16 | ENUMERATED {nb2} |

OPTIONAL,

| | | |
|---|---|---|
| groupWakeUpSignal-r16 | ENUMERATED {true} | OPTIONAL, |

| | |
|---|---|
| groupWakeUpSignalAlternation-r16 | ENUMERATED {true} |

```
  OPTIONAL
  ]]
}
```

wakeUpSignalMinGap-eDRX

wakeUpSignalMinGap-eDRX may be understood to indicate the minimum gap the UE may support between WUS or Group WUS (GWUS) and associated PO in case of eDRX in Frequency Division Duplexing (FDD), as specified in TS 36.304, version 16.5.0. Value ms40 corresponds to 40 ms, value ms240 corresponds to 240 ms and so on. If this field is included, the UE may be required to also indicate support for WUS or GWUS for paging in DRX.

At the end of Rel-15, a longer WUS gap of 1s or 2s was introduced to enable the use of a Wake-Up receiver (WUR), since, starting up the baseband receiver if a WUR is used for the detection of WUS may take longer time. If this is supported in the cell, an eNB may include timeOffset-eDRX-Long in the WUS-Config in SI, see above. In TS 36.304, version 16.5.0, the UE behavior for monitoring paging with WUS is specified, and in Table 7.4-1 it is indicated which WUS time gap the UE and the eNB, may be required to apply depending on the reported UE capability.

Paging with Wake Up Signal

Section 7.4 of TS 36.304, version 16.5.0 describes a specification of paging with wake up signal. According to this specification, paging with Wake Up Signal may only be used in the cell in which the UE most recently entered RRC_IDLE triggered by: a) reception of RRCEarlyDataComplete, or b) reception of RRCConnectionRelease not including noLastCellUpdate, or c) reception of RRCConnectionRelease including noLastCellUpdate and the UE was using (G) WUS in this cell prior to this Radio Resource Control (RRC) connection attempt.

If the UE is in RRC_IDLE, the UE may not be using GWUS according to clause 7.5 and the UE supports WUS, and WUS configuration may be provided in system information, the UE may be required to monitor WUS using the WUS parameters provided in System Information.

When DRX is used and the UE detects WUS, the UE may be required to monitor the following PO. When extended DRX is used and the UE detects WUS, the UE may be required to monitor the following numPOs POs or until a paging message including the UE's Non-Access Stratum (NAS) identity may be received, whichever may be earlier. If the UE does not detect WUS, the UE may not be required to monitor the following PO(s). If the UE missed a WUS occasion, e.g., due to cell reselection, it may monitor every PO until the start of the next WUS or until the paging time window (PTW) ends, whichever may be earlier. A PTW may be understood as a time window containing one or more paging occasions (POs) which may be required to be monitored by the UE in eDRX operation.

numPOs=Number of consecutive Paging Occasions (PO) mapped to one WUS provided in system information where (numPOs≥1).

The WUS configuration, provided in system information, may include a time-offset between the end of WUS and the start of the first PO of the numPOs POs the UE may be required to monitor. The timeoffset in subframes, used to calculate the start of a subframe g0, see TS 36.213, version 16.7.1, may be defined as follows. For a UE using DRX, it may be the signalled timeoffsetDRX. For a UE using eDRX, it may be the signalled timeoffset-eDRX-Short if timeoffset-eDRX-Long is not broadcasted. And for a UE using eDRX, it may be the value determined according to Table 7.4-1 if timeoffset-eDRX-Long is broadcasted.

TABLE 7.4-1
Determination of GAP between end of WUS and associated PO

| | | timeoffset-eDRX-Long | |
|---|---|---|---|
| | | 1000 ms | 2000 ms |
| UE Reported | 40 ms or | timeoffset-eDRX- | timeoffset-eDRX- |
| wakeUpSig- | not | Short | Short |
| nalMinGap- | reported | | |
| eDRX | 240 ms | timeoffset-eDRX- | timeoffset-eDRX- |
| | | Short | Short |
| | 1000 ms | timeoffset-eDRX-Long | timeoffset-eDRX-Long |
| | 2000 ms | timeoffset-eDRX- | timeoffset-eDRX-Long |
| | | Short | |

The timeoffset may be used to determine the actual subframe g0 as follows, taking into consideration resultant System Frame number (SFN) and/or Hyper Frame SFN (H-SFN) wrap-around of this computation: g0=PO-timeoffset, where PO is the Paging Occasion subframe as defined in clause 7.1.

For a UE using eDRX, the same timeoffset may apply between the end of WUS and associated first PO of the numPOs POs for all the WUS occurrences for a PTW.

The timeoffset, g0, may be used to calculate the start of the WUS as defined in TS 36.213, version 16.7.1.

In essence, the UE may only use WUR, or timeOffset-eDRX-Long, if it may be capable of starting up the main receiver as quickly as indicated by the value used in SI. If not, it may fall back to using timeOffset-eDRX-Short, without WUR.

Since UEs may share PO, the eNB may, in worst case, have to transmit up to 3 WUSs for one PO, for example, corresponding to timeoffsetDRX, timeoffset-eDRX-Short, and timeoffset-eDRX-Long.

FIG. 3 is a schematic diagram illustrating the use of eDRX and DRX WUS gaps for NB-IoT and LTE-M. In the non-limiting example depicted in FIG. 3, a first WUS is transmitted having a timeoffset-eDRX-Long between its transmission and that of the PDCCH in the PO. A second WUS is transmitted having a shorter, timeoffsetDRX, between the transmission of the second WUS and that of the PDCCH in the PO. After the PDCCH, the PDSCH may be transmitted.

### Wus UE Grouping Objective in Rel-16

In the Rel-16 WID, it was agreed that WUS should be further developed to also include UE grouping, such that the number of UEs that may be triggered by a WUS may be further narrowed down to a smaller subset of the UEs that may be associated with a specific paging occasion (PO). The objective was to specify the following set of improvements for machine-type communications for BL/CE UEs: Improved DL transmission efficiency and/or UE power consumption. Particularly, to specify support for UE-group wake-up signal (WUS) [RAN1, RAN2, RAN4].

The purpose may be understood to be to reduce the false paging rate, that is, to avoid that that a given UE may be unnecessarily woken up by a WUS transmission intended for another UE. This feature may be referred to as Rel-16 group WUS, or GWUS. However, this is not directly related to WUR and will not further be explained here.

### Rel-17 NR PEI

In Rel-17, discussions started on introducing a WUS for NR, then called ‘Paging Early Indication’ (PEI). However, since at the time no coverage enhancement was specified for NR, the only gain for Rel-17 PEI was that for the small fraction of UEs in bad coverage and with large synchronization error due to the use of longer DRX cycles. The gain for such UEs was that with the use of PEI they would typically only have to acquire one Synchronisation Signal Block (SSB) before decoding PEI, instead of up to 3 SSBs if PEI was not used, value according to UE vendors. Accordingly, for most UEs, Rel-17 PEI may not result in gains or increased performance.

Rel-17 PEI may also support UE grouping for false paging reduction, similar to the Rel-16 GWUS above, which may have some gains at higher paging load.

In RAN #93e it was agreed that PEI may be PDCCH-based, as seen in from the next subsection, making it much less interesting for WUR, since the main baseband receiver may be understood to be required for decoding PEI. That is, the main baseband received may be understood to not be able to be in sleep state, and therefore there may be no WUR gains.

### Rel-18 NR WUR

In Rel-18, there has been rather large interest to introduce WUR for NR. As explained above, the only specification support needed to be able to use a WUR in the UE, is the specification of a WUS and a long enough time gap between the WUS and the PDCCH in the PO, to allow the UE to start up the main receiver. Therefore, the main difference to Rel-17 PEI may be understood to be that the WUS in Rel-18 should not be PDCCH-based and allow for a simpler and low power receiver, that is, WUR, e.g., using On-Off Keying (OOK), modulation, and non-coherent detection.

In a Rel-18 preparatory email discussion, the moderator's summary for WUR was the following [RP-211664]. A first proposal, Proposal 1 (non-controversial) was, for UE power savings, to focus further RAN discussions on enhancements based on ultra-low power UE receiver and wake up signal, including whether the enhancement may target general purpose use cases or may target specific use cases such as REDCAP, XR. If included as part of Rel-18, relevant work may need to start with a study item to verify the benefits, feasibility, and applicable scenarios. The following was provided as a starting point for further discussions in determining the relevant work scope on UE power savings: a) performance evaluation UE power savings based on ultra-low power UE receiver and wake up signal (RAN1), b) hardware feasibility evaluation (RAN4), c) design of wake up signal for ultra-low power UE receiver (RAN1), and d) relevant procedures (RAN1, RAN2).

However, the WUR was also discussed in the parallel thread on Rel-18 eRedCap and here the conclusions were the following [RP-212221].

The applicability of WUS/WUR was discussed. The common desire was that a specified solution should be usable by all types of UEs, but not limited to RedCap UEs. It was also clarified that the prime targeted use case for this study should be RedCap, i.e., low-end IoT use cases. Studies and normative work on low-power receivers targeting Enhanced Mobile Broadband (eMBB), i.e., smart phone use cases, had been conducted in Rel-16 and Rel-17. Clarification on the relation of the WUS/WUR study to previous work on UE Power Saving was requested. According to the moderators, understanding, previous RAN work was based on existing NR signals, whereas this System Information (SI) is supposed to also look into potentially new signals.

For the so called RedCap evolution, the main goal was to further embrace new use cases, especially requiring low-cost devices and low energy consumption, and particularly, to study low power wake-up receiver/wake-up signal (WUR/WUS). The study was set to target ultra-low power WUS/WUR required by RedCap use cases. The specified solutions were to not be limited to RedCap UEs only. As opposed to the work on UE power savings in previous releases, this study was set to not require existing signals to be used as WUS. Solutions were requested to give justifiable gains compared to the existing Rel-16/17 UE power saving enhancements.

The objectives set were to: a) study use cases, evaluation methodology & Key Performance Indicators (KPIs), and compatibility with other UE power saving solutions, b) study and evaluate low-power wake-up receiver architectures, c) study and evaluate wake-up signal designs to support wake-up receivers, d) study and evaluate protocol changes needed to support wake-up receivers, e) study potential system impact, such as network and other UE's power consumption, coexistence with R17 RedCap and non-RedCap UEs, network coverage.

The power saving/energy efficiency enhancements that were set were enhanced DRX in RRC_INACTIVE (>10.24s), if not completed in R17, and to identify use cases and study corresponding protocol enhancements to support operation on intermittently available energy harvested from the environment. It was noted that how the devices harvest and store energy is outside the scope of 3GPP

That is, it remains to be seen if WUR will be introduced as a RedCap-specific feature under the RedCap Work Item (WI), or as a general NR feature in a separate WI.

For more details on e.g., suggestions on WUR architecture and design, receiver power vs. sensitivity trade-off see e.g., RP-212005, RP-212254, RP-212367, and RP-212427 which were submitted to RAN3 #93-e.

The benefit of WUR may be understood to be to reduce the energy consumption of the receiver, such that unless there is any paging and data for the UE, it may remain in a power saving state. This may extend the battery life of the device, or alternatively enable shorter downlink latency, e.g., shorter DRX, at a fixed battery life. For short-range communication, the WUR power may be low enough, ˜3 uW, that this may even, in combination with energy harvesting, enable that the WUR may be continuously on, that is, DRX or duty-cycling may be not used.

In spite of the benefits of wake-up signals, existing methods to wake-up wireless devices may result in a misuse, e.g., waste, of network resources, as well as energy resources.

### SUMMARY

As part of the development of embodiments herein, one or more challenges with the existing technology will first be identified and discussed.

In NB-IoT and LTE-M, the time gap between the WUS and the PO may be determined based on whether the UE may be configured with DRX or eDRX, but in practice, only the time gaps associated to eDRX may allow sufficiently long gaps for enabling WUR. This may be understood to be since 1s or 2s may be required to start up the main receiver. This is, however, a bad design choice since for Rel-18 WUR it is clear that the shorter the DRX cycle, the larger the WUR gain may be understood to be. This may be understood be since the more time the main receiver may be kept in a sleep state, the bigger the WUR gain may be. For Rel-18 NR WUR, it is not clear how the time gap between WUS and PO will be configured.

According to the foregoing, it is an object of embodiments herein to improve handling of a time gap.

According to a first aspect of embodiments herein, the object is achieved by a method, performed by a node. The method is being for handling a time gap. The node operates in a wireless communications network. The node determines a respective duration of a time gap. The time gap is between a transmission of one or more respective signals to wake-up the one or more wireless devices operating in the wireless communications network, and a beginning of a one or more respective paging occasions. The determining is based on a condition. The condition is independent of whether or not the one or more wireless devices use discontinuous reception (DRX) or extended discontinuous reception (eDRX). The node then initiates transmission of the one or more respective signals to the one or more wireless devices based on the determined respective duration.

According to a second aspect of embodiments herein, the object is achieved by a method, performed by a wireless device. The method is for handling the time gap. The wireless device operates in the wireless communications network. The wireless device determines the respective duration of the time gap. The time gap is between a transmission of a respective signal to wake-up the wireless device, and a beginning of a respective paging occasion for the wireless device. The determining is based on the condition. The condition is independent of whether or not the wireless device uses discontinuous reception or extended discontinuous reception. The wireless device then receives the respective signal based on the determined respective duration.

According to a third aspect of embodiments herein, the object is achieved by the node, for handling the time gap. The node is configured to operate in the wireless communications network. The node is further configured to determine the respective duration of the time gap between the transmission of the one or more respective signals to wake-up the one or more wireless devices configured to operate in the wireless communications network and the beginning of the one or more respective paging occasions. The determining is configured to be based on the condition. The condition is configured to be independent of whether or not the one or more wireless devices are configured to use discontinuous reception or extended discontinuous reception. The node is also configured to initiate the transmission of the one or more respective signals to the one or more wireless devices based on the respective duration configured to be determined.

According to a fourth aspect of embodiments herein, the object is achieved by the wireless device, for handling the time gap. The wireless device is configured to operate in the wireless communications network. The wireless device is further configured to determine the respective duration of the time gap between the transmission of the respective signal to wake-up the wireless device, and the beginning of the respective paging occasion for the wireless device. The determining is configured to be based on the condition. The condition is configured to be independent of whether or not the wireless device uses discontinuous reception or extended discontinuous reception. The wireless device is also configured to receive the respective signal based on the respective duration configured to be determined.

By the node determining the time gap based on the condition, the node be enabled to determine a time gap that may be specific for each wireless device of the one or more wireless devices. This may in turn enable the node to, in some examples, adaptively use the time gap that may be best suited for the one or more wireless devices, e.g., based on their respective capabilities, so that usage of the WUR may be optimized to maximize its advantages, e.g., to enable WUR energy consumption reduction while at the same time minimize the downlink latency. The determination being based on the condition which is independent of whether or not the wireless device uses discontinuous reception or extended discontinuous reception, may be understood to be advantageous since artificially linking the WUR gap/time offset to whether or not the wireless device uses discontinuous reception or extended discontinuous reception as NB-IoT and LTE-M may create an artificial limitation which may be understood to be unwanted.

By the node initiating transmission of the one or more respective signals to the one or more wireless devices based on the determined respective duration, the node may be enabled to, in some examples, adaptively page the one or more wireless devices by respectively using the time gap that may be best suited, respectively, for the one or more wireless devices, so that usage of the WUR may be optimized to maximize its advantages, e.g., to minimize the downlink latency taking into consideration the capabilities of the one or more wireless devices 130.

By the wireless device determining the time gap based on the condition, the wireless device may be enabled to then receive the respective signal based on the determined respective duration. This may in turn enable the wireless device to, in some examples, adaptively use the time gap that may be best suited for the wireless device, e.g., based on its respective capabilities, so that usage of the WUR may be optimized to maximize its advantages, e.g., to enable WUR energy consumption reduction while at the same time minimize the downlink latency. The determination being based on the condition which is independent of whether or not the wireless device uses discontinuous reception or extended discontinuous reception, may be understood to be advantageous since artificially linking the WUR gap/time offset to whether or not the wireless devices use discontinuous reception or extended discontinuous reception as NB-IoT and LTE-M may create an artificial limitation which may be understood to be unwanted.

By the wireless device receiving the signal based on the determined respective duration, the wireless device may be enabled to be paged using the time gap that may be best suited, for the wireless device, e.g., based on its capabilities, so that usage of the WUR may be optimized to maximize its advantages and to minimize the downlink latency for the wireless device.

### BRIEF DESCRIPTION OF THE DRAWINGS

Examples of embodiments herein are described in more detail with reference to the accompanying drawings, according to the following description.

FIG. 1 is a schematic diagram depicting an illustration of a location of a WUS and the paging occasion to which it is associated.

FIG. 2 is a schematic diagram depicting an illustration of WUS for NB-IoT and LTE-M.

FIG. 3 is a schematic diagram illustrating the use of eDRX and DRX WUS gaps for NB-IoT and LTE-M.

FIG. 4 is a schematic diagram depicting an example of a wireless communications network, according to embodiments herein.

FIG. 5 is a flowchart depicting a method in a node, according to embodiments herein.

FIG. 6 is a flowchart depicting a method in a wireless device, according to embodiments herein.

FIG. 7 is a schematic diagram illustrating a non-limiting example of WUS before legacy Paging Occasions, according to examples of embodiments herein.

FIG. 8 is a schematic diagram illustrating a non-limiting example of a new mapping of WUR UEs to Paging Occasions, according to examples of embodiments herein.

FIG. 9 is a schematic block diagram illustrating two embodiments, in panel a) and panel b), of a node, according to embodiments herein.

FIG. 10 is a schematic block diagram illustrating two embodiments, in panel a) and panel b), of a wireless device, according to embodiments herein.

FIG. 11 is a schematic block diagram illustrating a telecommunication network connected via an intermediate network to a host computer, according to embodiments herein.

FIG. 12 is a generalized block diagram of a host computer communicating via a base station with a user equipment over a partially wireless connection, according to embodiments herein.

FIG. 13 is a flowchart depicting embodiments of a method in a communications system including a host computer, a base station and a user equipment, according to embodiments herein.

FIG. 14 is a flowchart depicting embodiments of a method in a communications system including a host computer, a base station and a user equipment, according to embodiments herein.

FIG. 15 is a flowchart depicting embodiments of a method in a communications system including a host computer, a base station and a user equipment, according to embodiments herein.

FIG. 16 is a flowchart depicting embodiments of a method in a communications system including a host computer, a base station and a user equipment, according to embodiments herein.

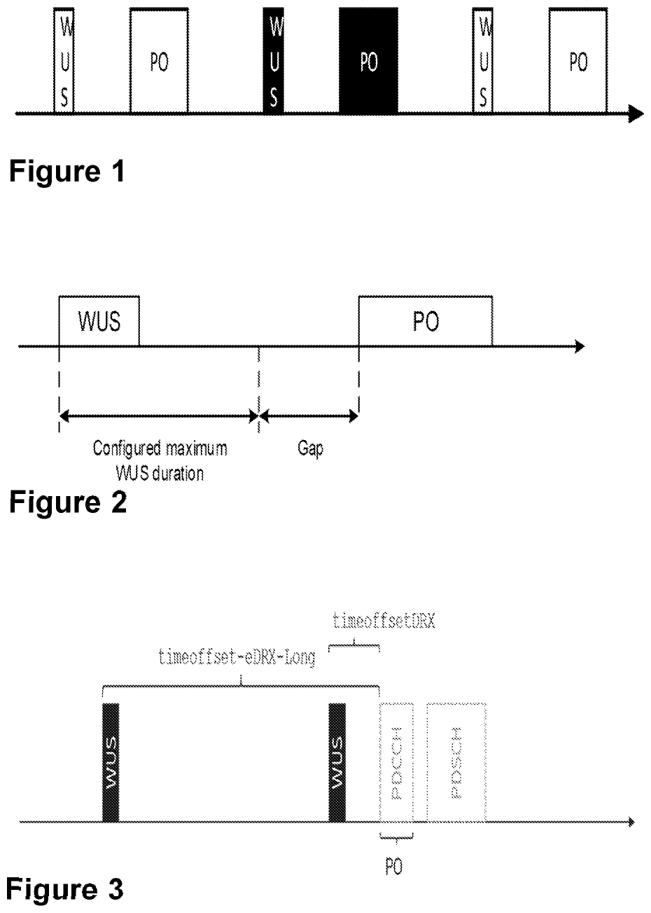

### DETAILED DESCRIPTION

Certain aspects of the present disclosure and their embodiments may provide solutions to the challenges presented in the Summary section or other challenges. Embodiments herein may be generally understood to relate to UE-specific Wake-up Radio. Embodiments herein may be generally understood to relate to different aspects of enabling the configuration of a UE-specific time gap between the WUS and the associated paging occasion. In one example, a gNB may apply the time gap as specified in the UE radio paging capabilities, and may page the UE in its legacy paging occasion. In another example, WUR specific POs may be used when paging UEs using WUR. In this way, one single time gap may be used per PO, and ensure that the gNB may have to transmit at most one WUS per PO.

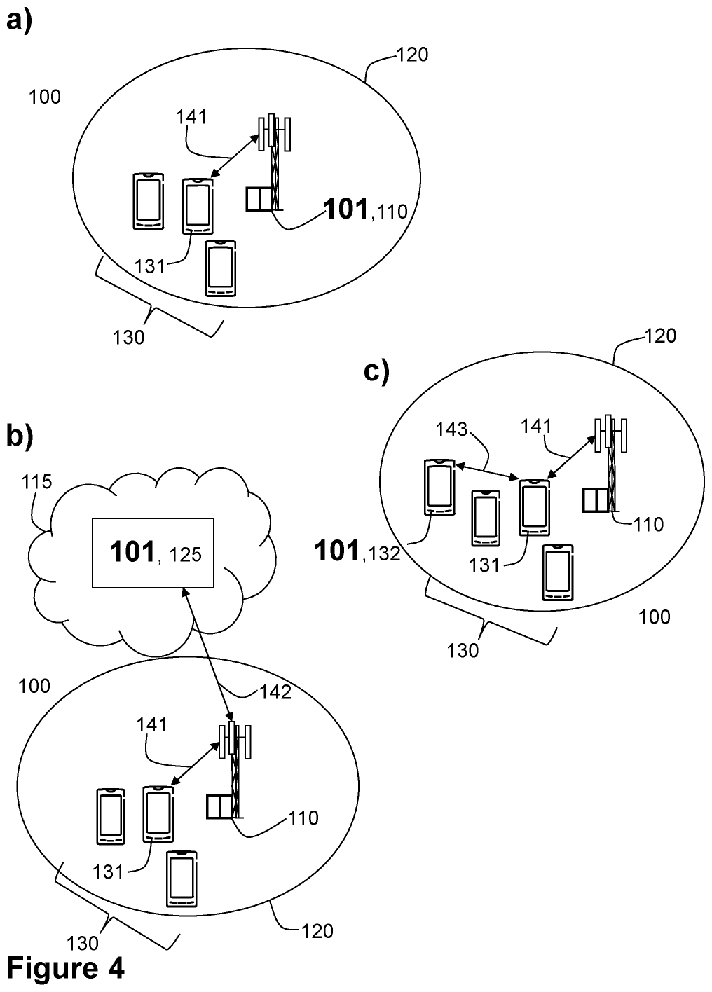

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments. FIG. 4 depicts three non-limiting examples, in panel a), panel b) and panel c), respectively, of a wireless network or wireless communications network 100, sometimes also referred to as a wireless communications system, cellular radio system, or cellular network, in which embodiments herein may be implemented. The wireless communications network 100 may be a 5G system, 5G network, or Next Gen System or network, or a younger system with similar functionality. In other examples, the wireless communications network 100 may instead, or in addition, support other technologies such as, for example, Long-Term Evolution (LTE), e.g. LTE-M, LTE Frequency Division Duplex (FDD), LTE Time Division Duplex (TDD), LTE Half-Duplex Frequency Division Duplex (HD-FDD), LTE operating in an unlicensed band, such as Licensed-Assisted Access (LAA), enhanced LAA (eLAA), further enhanced LAA (feLAA) and/or MulteFire. The wireless communications network 100 may support MTC, enhanced MTC (eMTC), IoT and/or NB-IoT. Yet in other examples, the wireless communications network 100 may instead, or in addition, support other technologies such as, for example Wideband Code Division Multiple Access (WCDMA), Universal Terrestrial Radio Access (UTRA) TDD, Global System for Mobile communications (GSM) network, GSM/Enhanced Data Rates for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), or any cellular network or system. Thus, although terminology from 5G/NR and LTE may be used in this disclosure to exemplify embodiments herein, this should not be seen as limiting the scope of the embodiments herein to only the aforementioned system.

The wireless communications network 100 may comprise a plurality of nodes, whereof a node 101 is depicted in the non-limiting example of FIG. 4. The node 101 may be any of a network node, such as the network node 110 described below, as e.g., depicted in the non-limiting example of panel a), a core network node, such as the core network node 125 described below, as e.g., depicted in the non-limiting example of panel b), and a wireless device, such as the another wireless device 132 described below, as e.g., depicted in the non-limiting example of panel c).

The wireless communications network 100 may comprise a plurality of network nodes, whereof a network node 110 is depicted in the non-limiting example of FIG. 4. The network node 110 is a radio network node. That is, a transmission point such as a radio base station, for example a gNB, an eNB, an eNodeB, or a Home Node B, a Home eNode B, or any other network node with similar features capable of serving a user equipment, such as a wireless device or a machine type communication device, in the wireless communications network 100. In some examples, the network node 110 may be a distributed node, and may partially perform its functions in collaboration with a virtual node in a cloud 115.

The wireless communications network 100 may cover a geographical area, which in some embodiments may be divided into cell areas, wherein each cell area may be served by a radio network node, although, one radio network node may serve one or several cells. In the example of FIG. 4, the network node 110 serves a cell 120. The network node 110 may be of different classes, such as, e.g., macro eNodeB, home eNodeB or pico base station, based on transmission power and thereby also cell size. In some examples, the network node 110 may serve receiving nodes with serving beams. The radio network node may support one or several communication technologies, and its name may depend on the technology and terminology used. Any of the radio network nodes that may be comprised in the wireless communications network 100 may be directly connected to one or more core networks.

The one or more networks may comprise a plurality of core network nodes, whereof a core network node 125 is depicted in the non-limiting example of panel b) in FIG. 4. The core network node 125 may be capable to communicate with any of the one or more wireless devices 130 described below via, e.g., Non-Access Stratum signalling. For example, the core network node 125 may be an Access and Mobility Management Function (AMF).

A plurality of wireless devices may be located in the wireless communication network 100, whereof one or more wireless devices 130 comprising a wireless device 131 are depicted in the non-limiting example of FIG. 4. The wireless communications network 100 may also comprise another wireless device 132. While the non-limiting examples of FIG. 4 depict the one or more wireless devices 130 as comprising three wireless devices, it may be understood that this is non-limiting and for illustration purposes only. The one or more wireless devices 130 may comprise additional wireless devices. In embodiments wherein the node 101 may be the another wireless device 132, as depicted in panel c) of FIG. 4, the another wireless device 132 may be able to communicate with the one or more wireless devices 130, e.g., directly, via device to device communication. Any of the one or more wireless devices 130, the wireless device 131 and the another wireless device 132 comprised in the wireless communications network 100 may be a wireless communication device such as a 5G UE, or a UE, which may also be known as e.g., mobile terminal, wireless terminal and/or mobile station, a mobile telephone, cellular telephone, or laptop with wireless capability, just to mention some further examples. Any of the one or more wireless devices 130, the wireless device 131 and the another wireless device 132 comprised in the wireless communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, a sensor, IoT device, NB-IoT device, device equipped with a wireless interface, such as a printer or a file storage device, modem, or any other radio network unit capable of communicating over a radio link in a communications system. Any of the one or more wireless devices 130, the wireless device 131 and the another wireless device 132 comprised in the wireless communications network 100 may be enabled to communicate wirelessly in the wireless communications network 100. The communication may be performed e.g., via a RAN, and possibly the one or more core networks, which may be comprised within the wireless communications network 100, or directly, device to device.

The node 101 may be configured to communicate within the wireless communications network 100 with the wireless device 131 over a first link 141, e.g., a radio link. The network node 110 may be configured to communicate within the wireless communications network 100 with the core network node 125 over a second link 142, e.g., a radio link or a wired link. The wireless device 131 may be configured to communicate within the wireless communications network 100 with the another wireless device 132 over a third link 143, e.g., a radio link.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first”, “second” and/or “third” herein may be understood to be an arbitrary way to denote different elements or entities, and may be understood to not confer a cumulative or chronological character to the nouns they modify, unless otherwise noted, based on context.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to a node, such as the node 101, e.g., a core network node (CNN), a gNB or a 5G UE or a UE, and embodiments related to a wireless device such as the wireless device 131, e.g., a UE.

Some embodiments herein will now be further described with some non-limiting examples.

In the following description, any reference to a/the UE, or simply “UE” may be understood to equally refer to any of the one or more wireless devices 130, e.g., the wireless device 131; any reference to a/the UEs may be understood to equally refer to the one or more wireless devices 130; any reference to a/the gNB, may be understood to equally refer to the network node 110; any reference to the a/the NW and/or a/the network may be understood to equally refer to the node 101; any reference to a/the core network and/or a/the AMF may be understood to equally refer to the core network node 125; any reference to a/the WUS(s) may be understood to equally refer to the one or more signals to wake-up the one or more wireless devices 130; any reference to a/the WUR may be understood to equally refer to the receiver to, e.g., specifically, receive the one or more signals to wake-up the one or more wireless devices 130, e.g., the wireless device 131; any reference to the a/the cell may be understood to equally refer to the cell 120.

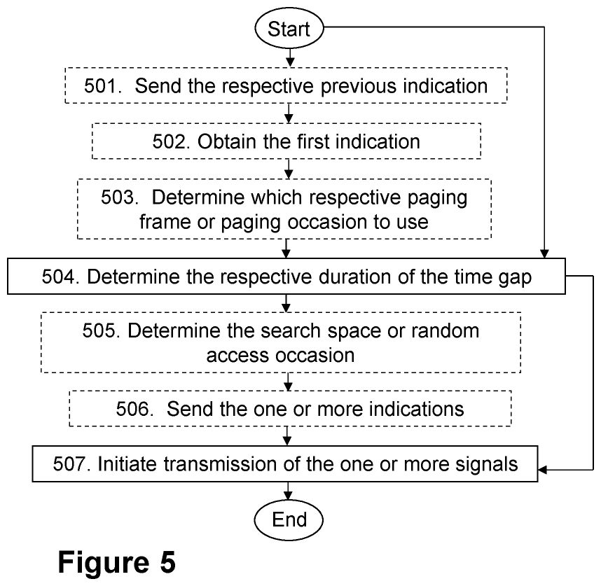

Embodiments of a method performed by a node, such as the node 101 will now be described with reference to the flowchart depicted in FIG. 5. The method may be understood to be for handling a time gap. The node 101 operates in a wireless communications network, such as the wireless communications network 100.

In some embodiments, the wireless communications network 100 may support at least one of: New Radio (NR), Long Term Evolution (LTE), LTE for Machines (LTE-M), enhanced Machine Type Communication (eMTC), IoT and Narrow Band Internet of Things (NB-IoT).

The node 101 may be one of: the network node 110, the core network node 125, and the another wireless device 132.

Several embodiments are comprised herein. In some embodiments, all the actions may be performed. In some embodiments, two or more actions may be performed. It should be noted that the examples herein are not mutually exclusive. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the node 101 is depicted in FIG. 5. Some actions may be performed in a different order than that shown FIG. 5. For example, Action 502 may be performed before Action 501. In FIG. 5, optional actions in some embodiments may be represented with dashed lines.

### Action 501

In this Action 501, the node 101 may send an indication, which may be referred to herein as a respective previous indication, to the one or more wireless devices 130. The respective previous indication may indicate a correspondence, e.g., a map or a table. The correspondence may be between a respective capability of the one or more wireless devices 130 and a respective duration of a time gap. The time gap may be between a transmission of one or more respective signals to wake-up one or more wireless devices 130 operating in the wireless communications network 100, and a beginning of a one or more respective paging occasions. The one or more respective signals to wake-up one or more wireless devices 130 may be e.g., WUSs.

The sending in this Action 501 may be performed via at least one of: Radio Resource Control (RRC) signalling, via System Information (SI) and via NAS signalling. The sending via RRC or SI may be performed in examples wherein the node 101 may be the network node 110. The sending via NAS signalling may be performed in examples wherein the node 101 may be the core network node 125. In other examples, wherein the node 101 may be the another wireless device 132, the sending in this Action 501 may be performed via a Sidelink (SL), e.g., D2D communication.

By sending the respective previous indication indicating the correspondence between the respective capability of the one or more wireless devices 130 and the respective duration of the time gap, the node 101 may enable the one or more wireless devices 130 to know which time gap to use, e.g., while camping in the cell 120. This may enable the node 101 to adaptively use the time gap that may be best suited for the one or more wireless devices 130, e.g., based on their respective capabilities, so that usage of the WUR may be optimized to maximize its advantages, e.g., to enable WUR energy consumption reduction while at the same time minimize the downlink latency.

### Action 502

The wireless device 131, as any of the one or more wireless devices 130, may initially report its WUR capability, e.g., the minimum required time between WUS and the PO which it may need to start up the main, e.g., baseband, receiver, to the network, e.g., to the node 101 as network node 110. In a likely implementation, this may use the legacy framework for UE capability reporting, and be quantized to a pre-determined range of values. Unlike the NB-IoT/LTE-M approach, this may not be connected to the use and support of eDRX, but rather connected to the use of WUR whenever paging or downlink signaling may be expected to be received, e.g., in any PDCCH search space, during DRX or eDRX, etc. In other words, the WUR time gap/offset should not be artificially connected to the use of eDRX or DRX, only on the hardware of the respective wireless device, e.g., the wireless device 131, and how quick it may be able to start the main receiver. This may be expected to be different for different UE vendors.

In this Action 502, the node 101 may obtain a first indication. The first indication may indicate the respective capability of the one or more wireless devices 130. The respective capability of the one or more wireless devices 130 may be to use a receiver to, e.g., specifically, receive the one or more respective signals to wake-up the one or more wireless devices 130, e.g., a WUR, e.g., supporting one time gap or a plurality of time gaps.

Obtaining may be receiving from another node, or retrieving from a memory.

The obtaining, e.g., receiving, in this Action 502 may be from the one or more wireless devices 130. This may be directly or indirectly.

The respective capability may be e.g., a WUR UE capability. The more different values included in the WUR UE capability for the WUS time gap, the more WUSs may have to be transmitted before a given PO if several wireless devices 130 are paged. For this reason, and to limit the number of capability signaling bits, the WUS time gaps may, as described herein, likely be limited to a few values/options in practice, and in specification. It may be noted that these may potentially also be connected to different types of wireless device, e.g., UE types, e.g. one longer WUS time gap used for RedCap type UEs and a shorter WUS time gap used for non-RedCap UEs, that is, Mobile Broadband (MBB) and all other more capable types of wireless devices, e.g., UE types.

Continuing the example above of using two WUR capabilities, one for RedCap UEs, and another one for MBB type UEs, in general, non-RedCap UEs. If a wireless device 130 supports WUR, it may also indicate which WUS time gap it supports, or it may be implicit for the type of wireless device 130, e.g., UE type. The network node 110, e.g., a gNB, for example, as node 101, may, in SI, broadcast indicate if it supports WUR, and one or both of the two WUS time gaps.

In one example, there may be one WUR capability which may be used by different UE types. By knowing the type of wireless device 130, e.g., UE type, and the capability of the wireless device 130, e.g., UE capability, the node 101 as network node 110, e.g., a gNB, may know which exact WUS time gap the wireless device 130 may support. In this example, the value or values indicated by the one or more wireless devices 130 may be mapped into different WUR time gap values depending on the type of wireless device 130, e.g., UE type.

In another example, the node 101 as network node 110, e.g., a gNB, may support only one WUS time gap, e.g., to avoid having to transmit multiple WUSs before a given PO. A wireless device 130 may then only monitor paging using WUR in the cell 120 if its reported WUS time gap capability is shorter than the value used in the cell 120, such that it may have time to start up the main/baseband receiver before the PO. That is, the one or more wireless devices 130 may still support different WUS gap capability, but the network node 110 may only use one value in the cell 120. Thus, in this example, it may be up to the one or more wireless devices 130 to indicate support for WUS in case the implementation supports the WUS time gap as indicated by the network node 110, e.g., long enough, and that the time gap duration may be such the one or more wireless devices 130 may accept waking up or starting the WUR according to the time gap, e.g., the gap may not be too long to result in increased power consumption compared to not using WUS/WUR.

In yet another example, the WUR capability may be reduced to supporting a given pre-determined WUS time gap, both on the side of the wireless device 130 and the network side. In this case, only 1 bit may be required both for the reporting of the respective capability of the one or more wireless devices 130, e.g., the UE WUR capability reporting, and the WUR support in the cell 120, e.g., in SI.

By obtaining the first indication indicating the respective capability of the one or more wireless devices 130 in this Action 502, the first node 101 may be enabled to then determine, in Action 504, which time gap to apply for the one or more wireless devices 130 to ensure the one or more wireless devices 130 may use the WUR for detection of the one or more respective signals to wake-up the one or more wireless devices 130, e.g., WUS while considering the respective capabilities of the one or more wireless devices 130. This may enable the node 101 to adaptively use the time gap that may be best suited for the one or more wireless devices 130, e.g., based on its respective capabilities, so that usage of the WUR may be optimized to maximize its advantages, e.g., to enable WUR energy consumption reduction while at the same time minimize the downlink latency.

### Action 503

In this Action 503, the node 101 may determine, which respective paging frame or paging occasion to use for the one or more wireless devices 130, out of a plurality of paging frames or paging occasions.

Determining in this Action 503 may comprise deciding, deriving or calculating autonomously, receiving from another node, or retrieving from a memory.

A paging frame may be understood as the radio frame in which the UE may be required to monitor paging according to TS 38.304, v. 16.6.0.

In one alternative of this example, WUR operation may only be configured in the current cell 120, and which POs the one or more wireless devices 130, e.g., the wireless device 131, may need to monitor for paging when WUR is being used may be part of the WUR configuration and wireless device 130-specifically configured for the one or more wireless devices 130, e.g., via dedicated RRC signaling. This may work well for stationary wireless devices 130, but may not enable use of WUR, at least efficiently, for mobile wireless devices 130, which may have to configure WUR in any new cell they enter.

In an alternative of the example, paging frames (PFs) and POs may be mapped to different WUS gaps, either based on the signaled respective capabilities of the one or more wireless devices 130 capabilities, or what may be configured in broadcast SI in the cell 120. In legacy operation, see TS 36.304, 16.5.0 for LTE and TS 38.304, v. 16.6.0 for NR, the users may be uniformly distributed over the PF and PO “bins”. Since the UE_ID may be understood to be quasi-random, there may be uniform distribution over the PFs and POs, and all one or more wireless devices 130 may experience approximately the same ‘false paging ratio’, that is, the likelihood of having to read a paging message even though it is another wireless device 130 that may be being paged. The expression may look like follows, see Section 7.1 in TS 38.304, v. 16.6.0 for clarification of terms:

The SubFrame Number (SFN) for the PF may be determined by:

(SFN+PF_offset)mod T=(T div N)*(UE_ID mod N).
Index (i_s), indicating the index of the PO may be determined by:
i_s=floor (UE_ID/N) mod Ns

As described in TS 38.304, T may be understood to the DRX cycle and N may be understood to be the numbers of PFs configured in the cell 120.

In a first example, different sets of PFs and/or POs may be used for one or more wireless devices 130 with different WUS gap. That is, e.g., separate time or frequency regions may be defined which may be non-overlapping with legacy, in which then the legacy equations above may be applied to determine the PF and POs, e.g., i_s index, of the wireless device 131. It may be noted that the selection of WUS gap-specific resources may have to be done before the uniform distribution of the one or more wireless devices 130 to ensure all wireless devices 130 wireless devices 130 sharing a PF or PO may have the same WUS gap.

With this approach, the wireless devices 130 may be configured with WUR in the entire network, and if the wireless device 131 enters a new cell it may determine the WUR POs from the above equation without the need to first setup a connection and receive a dedicated configuration, that is, if WUR is supported in the cell and by the wireless device 131.

### New Paging Occasion Mapping

In a second group of examples of embodiments herein, the one or more wireless devices 130 may instead be mapped to new POs depending on their WUS gap capability, instead of being mapped to POs according to the UE_IDs. In this way, UEs using the same WUS time gap may be grouped to share POs such that the first node 101 as network node 110 may at most have to transmit one WUS for a given PO, even when multiple wireless devices 130 may be being paged. An example is shown in FIG. 8.

By determining which respective paging frame or paging occasion to use for the one or more wireless devices 130 in this Action 503, the first node 101 may ensure that wireless devices 130 with different WUS gap capability may not obtain the same PO, and hence share POs. In this way, the false paging, that is, that any of the one or more wireless devices 130, e.g., the wireless device 131, may be unnecessarily woken up when there is paging for another wireless device, may be minimized and hence the energy consumption reduction maximized.

### Action 504

In this Action 504, the node 101 determines a respective duration of a time gap.

The time gap is between a transmission of one or more respective signals to wake-up the one or more wireless devices 130 operating in the wireless communications network 100, and a beginning of a one or more respective paging occasions.

The one or more respective signals to wake-up the one or more wireless devices 130 may be, e.g., Wake-Up Signals, WUSs, PEI, or equivalent.

Determining in this Action 504 may comprise deciding, deriving or calculating autonomously, receiving from another node, or retrieving from a memory.

The determining in this Action 504 is based on a condition.

The condition is independent of whether or not the one or more wireless devices 130 use discontinuous reception (DRX) or extended discontinuous reception (eDRX).

In some embodiments, the condition may be one of the following.

According to a first option, the condition may be a respective type of the one or more wireless devices 130; the respective type may be, e.g., RedCap, non-RedCap. As explained earlier, one longer WUS time gap may be used for RedCap type UEs and a shorter WUS time gap may be used for non-RedCap UEs, that is, Mobile Broadband (MBB) and all other more capable types of wireless devices, e.g., UE types.

The value or values indicated by the one or more wireless devices 130, e.g., in Action 502, may be mapped into different WUR time gap values depending on the type of wireless device 130, e.g., UE type. In another example, the node 101 may support only one WUS time gap, e.g., to avoid having to transmit multiple WUSs before a given PO.

According to a second option, the condition may be the first indication, as obtained in Action 502, indicating the respective capability of the one or more wireless devices 130 to use the receiver to, e.g., specifically, receive the one or more respective signals to wake-up the one or more wireless devices 130, e.g., a WUR, and/or e.g., to use wake-up radio. The first node 101 may, upon reception of the WUR capability of the one or more wireless devices 130, e.g., the min time gap required, in the ‘UE radio paging capabilities’ contained in the paging message from the Access and Mobility Management Function (AMF), be able to determine, in this Action 504, which WUS time gap to apply for the one or more wireless devices 130 to ensure the one or more wireless devices 130 may use the WUR for detection of the WUS. In one example, there may be one WUR capability which may be used by different UE types. By knowing the type of wireless device 130, e.g., UE type, and the capability of the wireless device 130, e.g., UE capability, the node 101 may know which exact WUS time gap the wireless device 130 may support. In some examples, the determining in this Action 504 of the respective duration of the time gap may be based on a correspondence, e.g., a map or a table.

The correspondence may be between the respective capability of the one or more wireless devices 130 and the respective duration of the time gap. Action 501 may be performed in embodiments wherein the determining in this Action 504 of the respective duration of the time gap may be based on the correspondence between the respective capability of the one or more wireless devices 130 and the respective duration of the time gap.

According to a third option, the condition may be a respective duration of the time gap respectively supported by the one or more wireless devices 130. It may be up to the one or more wireless devices 130 to indicate support for WUS in case the implementation supports the WUS time gap as indicated by the network node 110, e.g., long enough, and that the time gap duration may be such the one or more wireless devices 130 may accept waking up or starting the WUR according to the time gap, e.g., the gap may not be too long to result in increased power consumption compared to not using WUS/WUR.

According to a fourth option, the condition may be a respective first identity of the one or more wireless devices 130. The first identity may be, e.g., UE-ID.

According to a fifth option, the condition may be a second identity of the cell 120 wherein the one or more wireless devices 130 are respectively located, e.g., at the time of the determining 504. In some examples, the time gap may be pre-determined. In yet another example, the WUR capability may be reduced to supporting a given pre-determined WUS time gap. The pre-determined WUS time gap may for example be a value which may be a fixed value in the specification, or a value in the specification depending on another configuration of a particular cell such as the cell 120 or gNB, such as the node 101 as network node 110. In one example, there may be different values e.g., in a table, depending on the frequency band the cell 120 or the network node 110 may operate in or the used subcarrier spacing (SCS) or other physical characteristics or configuration.

The determining in this Action 504 of the respective duration of the time gap may be respectively based on the determined respective paging frame or paging occasion. As stated earlier, PFs and POs may be mapped to different WUS gaps, either based on the signaled respective capabilities of the one or more wireless devices 130 capabilities, or what may be configured in broadcast SI in the cell 120.

It may be noted that the selection of WUS gap-specific resources may have to be done before the uniform distribution of the one or more wireless devices 130 to ensure all wireless devices 130 wireless devices 130 sharing a PF or PO may have the same WUS gap.

In one case, a frequency offset/differentiation may be used, see e.g., FIG. 8. A frequency offset or differentiation may be understood as using a different frequency location for different WUR gaps. The another wireless device 132, or the network node 110, when paging the wireless device 131, may first determine, in this Action 503, which set of PFs/POs to use. A mapping between the WUS gap and the frequency offset/differentiation may be provided in SI. The determination of the PF and PO of the wireless device 131 may then use the legacy equation above. One way to achieve this may be to define a separate Control Resource Set (CORESET), e.g., CORESET #0, for wireless devices 130 using WUR, and separate, e.g., non-overlapping, CORESET #0s for WUR wireless devices 130 with different WUS gap capability. This may ensure that wireless devices 130 with different WUS gaps may monitor paging in different frequency regions within the system bandwidth, and in each frequency region the legacy equations above may then be reused to determine the PF and PO. The above may be generalized to using separation initial DL BandWidth Parts (BWP) for WUR paging.

In one case, a time offset/differentiation may be used. A time offset or differentiation may be understood as using a different WUS offset/gap depending on the capability of a wireless device for a required time to start up the main receiver for reception of PDCCH. The first node 101, e.g., another wireless device 132, or the network node 110, when paging the wireless device 131, may first determine, in this Action 503, which set of PFs/POs to use. A mapping between the WUS gap and the time offset/differentiation may be provided in SI. The determination of the PF and PO of the wireless device 131 may then use the legacy equation above.

In one example implementation of the above, different values of PF_offset may be used for different WUS gaps to achieve the time differentiation, e.g., a mapping such as the following may be provided in SI:

| WUS gap: | PF_offsetWUR: |
|---|---|
| 500 ms | 5 |
| 1000 ms | 10 |
| 3000 ms | 20 |

Since legacy UEs may use the existing PF_offset parameter, a new one may have the be introduced, and may be only applied for WUR capable wireless devices 130, PF_offsetWUR. The legacy equation may be modified in the following way, addition in bold:

$$( S F N + PF\_offset + PF\_offsetWUR ) mod T = {( T div N )}^{*} ( UE\_ID mod N )$$

This new Information Element (IE) may for example be added to the RACH-ConfigGeneric configuration:

| | |
|---|---|
| RACH-ConfigGeneric ::= | SEQUENCE { |
| prach-ConfigurationIndex | INTEGER (0..255), |
| msg1-FDM | ENUMERATED {one, two, four, |

eight},

| | |
|---|---|
| msg1-FrequencyStart | INTEGER |

(0..maxNrofPhysicalResourceBlocks-1),

| | |
|---|---|
| zeroCorrelationZoneConfig | INTEGER(0..15), |
| preambleReceivedTargetPower | INTEGER (−202..−60), |
| preambleTransMax | ENUMERATED {n3, n4, n5, n6, |

n7, n8, n10, n20, n50, n100, n200},

| | |
|---|---|
| powerRampingStep | ENUMERATED {dB0, dB2, dB4, |

dB6},

| | |
|---|---|
| ra-ResponseWindow | ENUMERATED {sl1, sl2, sl4, |

```
sl8, sl10, sl20, sl40, sl80},
  ...,
  [[
```

| | |
|---|---|
| prach-ConfigurationPeriodScaling-IAB-r16 | ENUMERATED |
| {scf1,scf2,scf4,scf8,scf16,scf32,scf64} | OPTIONAL, |

-- Need R

| | |
|---|---|
| prach-ConfigurationFrameOffset-IAB-r16 | INTEGER (0..63) |

OPTIONAL, -- Need R

| | |
|---|---|
| prach-ConfigurationSOffset-IAB-r16 | INTEGER (0..39) |

OPTIONAL, -- Need R

| | |
|---|---|
| ra-ResponseWindow-v1610 | ENUMERATED { sl60, |
| sl160} | OPTIONAL, -- Need R |
| prach-ConfigurationIndex-v1610 | INTEGER (256..262) |

OPTIONAL, -- Need R

| | |
|---|---|
| pf-offsetWUS-v18xy | ENUMERATED {ms5, ms10, ms20} |

```
      OPTIONAL -- Need R
  ]]
}
```

By the node 101 determining the time gap based on the condition, the node 101 be enabled to determine a time gap that may be specific for each wireless device of the one or more wireless devices 130. This may in turn enable the node 101 to, in some examples, adaptively use the time gap that may be best suited for the one or more wireless devices 130, e.g., based on their respective capabilities, so that usage of the WUR may be optimized to maximize its advantages, e.g., to enable WUR energy consumption reduction while at the same time minimize the downlink latency. The determination being based on the condition which is independent of whether or not the wireless device uses discontinuous reception or extended discontinuous reception, may be understood to be advantageous since artificially linking the WUR gap/time offset to whether or not the wireless device uses discontinuous reception or extended discontinuous reception as NB-IoT and LTE-M may create an artificial limitation which may be understood to be unwanted.

### Action 505

In this Action 505, the node 101 may determine, based on the determined respective duration of the time gap, a respective at least one of: search space, and random access occasion.

Determining in this Action 505 may comprise deciding, deriving or calculating autonomously, receiving from another node, or retrieving from a memory.

In another example implementation of the above, separate pagingSearchSpace as specified in TS 38.213, 16.7.0 may be used for different WUS gaps, which effectively may mean that different slots may be used for different WUS gaps.

Separate Physical Random Access CHannels (PRACH)/Random Access Occasions (ROs) may alternatively be configured for different WUS gaps. A new information element (IE) may be added to the common RRC configuration in SI to indicate for which WUS gap the PRACH configuration may be applicable. This IE may be added in a similar way to the parameter above, but it may have to be ensured the these resources may not be used by legacy UEs, not being able to understand or cope with the WUS gap.

| | |
|---|---|
| RACH-ConfigGeneric ::= | SEQUENCE { |
| prach-ConfigurationIndex | INTEGER (0..255), |
| msg1-FDM | ENUMERATED {one, two, four, |

eight},

| | |
|---|---|
| msg1-FrequencyStart | INTEGER |

(0..maxNrofPhysicalResourceBlocks-1),

| | |
|---|---|
| zeroCorrelationZoneConfig | INTEGER(0..15), |
| preambleReceivedTargetPower | INTEGER (−202..−60), |
| preambleTransMax | ENUMERATED {n3, n4, n5, n6, |

n7, n8, n10, n20, n50, n100, n200},

| | |
|---|---|
| powerRampingStep | ENUMERATED {dB0, dB2, dB4, |

dB6},

| | |
|---|---|
| ra-ResponseWindow | ENUMERATED {sl1, sl2, sl4, |

```
sl8, sl10, sl20, sl40, sl80},
  ...,
  [[
```

| | |
|---|---|
| prach-ConfigurationPeriodScaling-IAB-r16 | ENUMERATED |
| {scf1,scf2,scf4,scf8,scf16,scf32,scf64} | OPTIONAL, |

-- Need R

| | |
|---|---|
| prach-ConfigurationFrameOffset-IAB-r16 | INTEGER (0..63) |

OPTIONAL, -- Need R

| | |
|---|---|
| prach-ConfigurationSOffset-IAB-r16 | INTEGER (0..39) |

OPTIONAL, -- Need R

| | |
|---|---|
| ra-ResponseWindow-v1610 | ENUMERATED { sl60, |
| sl160} | OPTIONAL, -- Need R |
| prach-ConfigurationIndex-v1610 | INTEGER (256..262) |

OPTIONAL, -- Need R

| | |
|---|---|
| WUSgap-v18xy | ENUMERATED {ms500, ms1000, ms3000} |

```
      OPTIONAL -- Need R
  ]]
}
```

The above example may ensure that wireless devices 130 with different WUS gap capability may not obtain the same PO, and hence share POs. In this way, the false paging, that is, that any of the one or more wireless devices 130, e.g., the wireless device 131, may be unnecessarily woken up when there is paging for another wireless device, may be minimized and hence the energy consumption reduction maximized.

### Action 506

In this Action 506, the node 101 may send one or more indications.

The sending in this Action 506 may be towards the one or more wireless devices 130.

Towards may be understood to mean directly, e.g., from the network node 110, or indirectly, e.g., from the core network node 125.

The one or more indications may respectively indicate a result of the determined respective duration of the time gap.

The sending in this Action 506 may be performed via at least one of: Radio Resource Control (RRC) signalling, via System Information (SI) and via NAS signalling. The sending via RRC or SI may be performed in examples wherein the node 101 may be the network node 110. The sending via NAS signalling may be performed in examples wherein the node 101 may be the core network node 125. In other examples, wherein the node 101 may be the another wireless device 132, the sending in this Action 501 may be performed via a SL, e.g., D2D communication.

In some examples, the one or more indications may comprise a mapping between the WUS gap and the time offset/differentiation provided in SI.

In some examples, the one or more indications may comprise a mapping between the WUS gap and the frequency offset/differentiation provided in SI.

In other examples, the one or more indications may comprise the WUR support in the cell, e.g., in SI. The first node 101 as network node 110 may have a limited support for WUR. First of all, it may be broadcast in SI if WUR may be being used in the cell 120. Secondly, the first node 101 as network node 110 may indicate in SI which WUR value or values it may support, the minimum WUS time gap, or the maximum WUS time gap it may support.

In some examples, the one or more indications may indicate a result of the respective at least one of: search space, and random access occasion, as determined in Action 505, e.g., the new IE added to the common RRC configuration in SI to indicate for which WUS gap the PRACH configuration may be applicable.

By sending the one or more indications indicating the result of the determined respective duration of the time gap in this Action 506, the node 101 may enable the one or more wireless devices 130 to know which gap may be used to transmit the one or more respective signals to the one or more wireless devices 130, so that, in some examples, the node 101 may adaptively page the one or more wireless devices 130 by respectively using the time gap that may be best suited, respectively, for the one or more wireless devices 130, e.g., considering their respective capabilities, in a way that usage of the WUR may be optimized to maximize its advantages, e.g., to minimize the downlink latency with the capabilities of the wireless device in mind.

### Action 507

In this Action 507, the node 101 initiates transmission of the one or more respective signals to the one or more wireless devices 130.

Transmitting may be, e.g., sending.

Initiating may be understood as triggering, enabling, facilitating or starting. For example, in examples wherein the node 101 may be the core network node 125, the node 101 may enable the network node 110 to perform the transmission, e.g., via the first link 141. In examples wherein the node 101 may be the network node 110 or the another wireless device 132, the node 101 may start performing the transmission, e.g., via the first link 141 or the third link 143, respectively.

The initiating transmission in this Action 507 of the one or more respective signals to the one or more wireless devices 130, is based on the determined respective duration. That is, the node 101 may transmit the one or more respective signals to the one or more wireless devices 130 using the respective duration of the time gap between the one or more respective signals and a respective paging occasion.

In some examples, the initiating in this Action 507 of the transmission of the one or more respective signals to the one or more wireless devices 130 may be based on at least one of the following.

According to a first option, the initiating in this Action 507 of the transmission of the one or more respective signals to the one or more wireless devices 130 may be based on the one or more wireless devices 130 respectively supporting reception using the receiver to, e.g., specifically, receive the one or more respective signals to wake-up the one or more wireless devices 130, e.g., a WUR Wake-up receiver.

According to a second option, the initiating in this Action 507 of the transmission of the one or more respective signals to the one or more wireless devices 130 may be based on the receiver to, e.g., specifically, receive the one or more respective signals to wake-up the one or more wireless devices 130, e.g., a WUR, and/or e.g., wake-up radio, being supported in the cell 120 wherein the one or more wireless devices 130 may be respectively located, e.g., at the time of the determining 504.

According to a third option, the initiating in this Action 507 of the transmission of the one or more respective signals to the one or more wireless devices 130 may be based on a first configuration of a respective wireless device 131 for the receiver to, e.g., specifically, receive the one or more respective signals to wake-up the one or more wireless devices 130, e.g., WUR, matching a second configuration for the receiver, e.g., WUR, at the cell 120.

The first node 101 as network node 110 may transmit WUS before the PO in which it may intend to page to the wireless device 131 if and only if a) the wireless device 131 supports WUR according to the wireless device 131 capabilities signaling in the paging message from the AMF, b) WUR is supported in the cell 120 and that is broadcast in SI, and c) the WUR paging capability of the wireless device 131 fulfils the requirements of the WUR configuration used in the cell 120. An example of condition c) may be that, if the first node 101 as network node 110 broadcasts that a maximum WUS time gap of 2s is used in the cell 120, the first node 101 as network node 110 may only use WUS when paging the wireless device 131 if the WUS time gap capability of the wireless device 131 is shorter than 2s. If all conditions are fulfilled, the first node 101 as network node 110 may use the WUS time gap capability of the wireless device 131 as signaled.

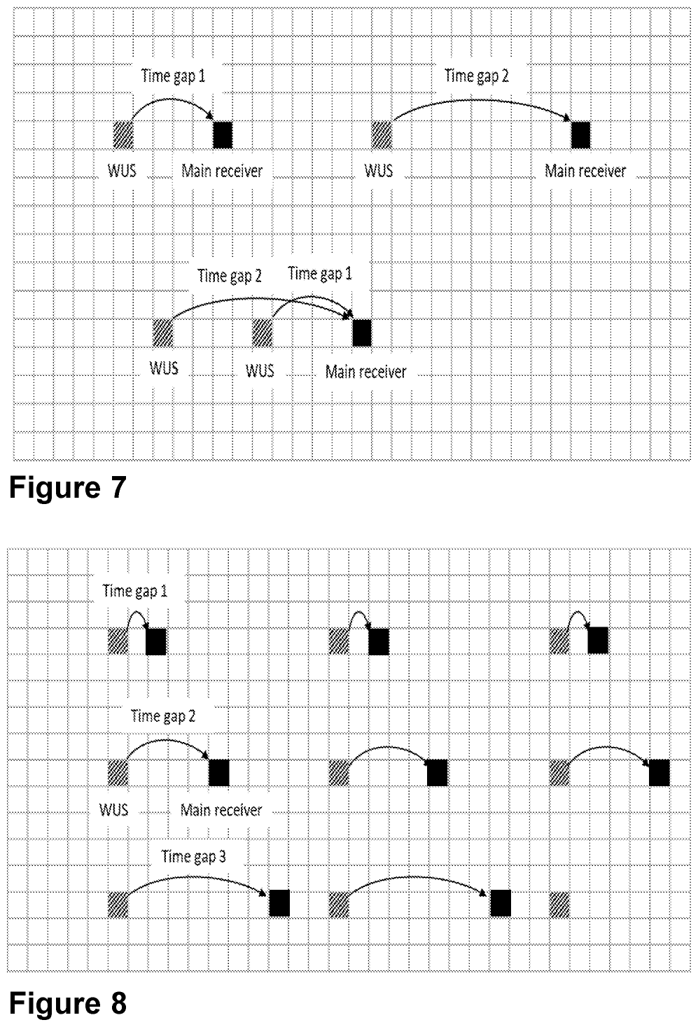

Since many wireless devices 130 may share a given PO, the first node 101 as network node 110 may have to transmit several WUSs before a PO, e.g., see bottom part of FIG. 7. The more different values included in the WUR UE capability for the WUS time gap, the more WUSs may have to be transmitted before a given PO if several wireless devices 130 are paged.

By the node 101 initiating transmission of the one or more respective signals to the one or more wireless devices 130 based on the determined respective duration, the node 101 may be enabled to, in some examples, adaptively page the one or more wireless devices 130 by respectively using the time gap that may be best suited, respectively, for the one or more wireless devices 130, e.g., considering their respective capabilities, so that usage of the WUR may be optimized to maximize its advantages, e.g., to minimize the downlink latency with the capabilities of the one or more wireless devices 130 in mind.

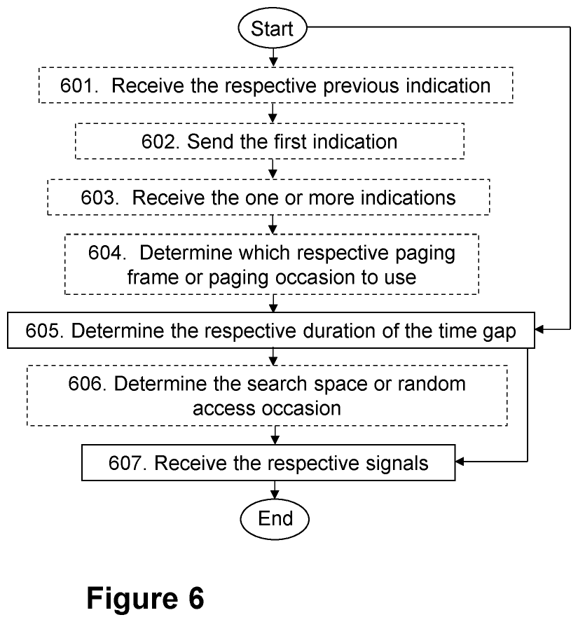

Embodiments of a method, performed by a wireless device, such as the wireless device 131, will now be described with reference to the flowchart depicted in FIG. 6. The method may be understood to be for handling the time gap. The wireless device 131 operates in a wireless communications network, such as the wireless communications network 100.

In some embodiments, the wireless communications network 100 may support at least one of: New Radio (NR), Long Term Evolution (LTE), LTE for Machines (LTE-M), enhanced Machine Type Communication (eMTC), IoT and Narrow Band Internet of Things (NB-IoT).

Several embodiments are comprised herein. The method may comprise two or more of the following actions. In some embodiments, all the actions may be performed. It should be noted that the examples herein are not mutually exclusive. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the wireless device 131 is depicted in FIG. 6. In FIG. 6, optional actions in some embodiments may be represented with dashed lines.

The detailed description of some of the following corresponds to the same references provided above, in relation to the actions described for the node 101 and will thus not be repeated here to simplify the description. For example, the one or more signals to wake-up the one or more wireless devices 130 may be, e.g., Wake-Up Signals, WUSs, PEI, or equivalent.

### Action 601

In this Action 601, the wireless device 131 may receive the respective previous indication. The receiving in this Action 603 may be from the node 101. The respective previous indication may indicate the correspondence.

The correspondence may be between the respective capability of the wireless device 131 and the respective duration of the time gap.

The node 101 may be one of: the network node 110, the core network node 125, and the another wireless device 132.

The receiving in Action 601 may be performed via at least one of: RRC signalling, via SI and via NAS signalling. The receiving via RRC or SI may be performed in examples wherein the node 101 may be the network node 110. The receiving via NAS signalling may be performed in examples wherein the node 101 may be the core network node 125. In other examples, wherein the node 101 may be the another wireless device 132, the receiving in Action 601 may be performed via a SL, e.g., D2D communication.

### Action 602

In this Action 602, the wireless device 131 may send the first indication.

The first indication may indicate the respective capability of the wireless device 131. The respective capability of the wireless device 131 may be to use the receiver to, e.g., specifically, receive the one or more respective signals to wake-up the one or more wireless devices 130, e.g., the wireless device 131, e.g., a WUR, e.g., supporting one time gap or the plurality of time gaps.

The sending in this Action 602 may be to the first node 101. This may be directly, e.g., to the network node 110 or to the another wireless device 132, or indirectly, e.g., via the network node 110 to the core network node 125.

The receiver to, e.g., specifically, receive the one or more respective signals to wake-up the one or more wireless devices 130 may be understood to refer to the type of signals in a generic way, e.g., WUS, and not to mean that the receiver may have to be able to receive all the signals, to all of the one or more wireless devices 130, e.g., all the WUSs.

The time gap is between the transmission of the one or more respective signals to wake-up the one or more wireless devices 130 operating in the wireless communications network 100, and the beginning of the one or more respective paging occasions.

The one or more respective signals to wake-up the one or more wireless devices 130 may be, e.g., Wake-Up Signals, WUSs, PEI, or equivalent.

### Action 603

In this Action 603, the wireless device 131 may receive the indication. That is, one of the one or more indications sent by the node 101 in Action 506.

The receiving in this Action 603 may be from the node 101 operating in the wireless communications network 100, directly, e.g., from the network node 110, or indirectly, e.g., from the core network node 125.

The node 101 may be one of: the network node 110, the core network node 125, and the another wireless device 132.

The indication may respectively indicate the result of the determined respective duration of the time gap. That is, as determined by the node 101 in Action 504.

In this Action 603, the wireless device 131 may receive the one or more indications the node 101 may have sent in Action 506. Another indication of the one or more indications may for example indicate the respective paging frame or paging occasion to use, as the node 101 may have determined in Action 503.

The receiving in any of Action 601 and/or Action 603 may be performed via at least one of: RRC signalling, via SI and via NAS signalling. The receiving via RRC or SI may be performed in examples wherein the node 101 may be the network node 110. The receiving via NAS signalling may be performed in examples wherein the node 101 may be the core network node 125. In other examples, wherein the node 101 may be the another wireless device 132, the receiving in any of Action 601 and/or Action 603 may be performed via a SL, e.g., D2D communication.

### Action 604

In this Action 604, the wireless device 131 may determine which respective paging frame or paging occasion to use, out of the plurality of paging frames or paging occasions.

Determining in this Action 604 may comprise deciding, deriving or calculating autonomously, receiving from another node, or retrieving from a memory. The another node may be for example the node 101, which may have indicated the respective paging frame or paging occasion to use, as it may have determined in Action 503, in one of the one or more indications it may have sent in Action 506.

### Action 605

In this Action 605, the wireless device 131 determines the respective duration of the time gap.

The time gap is between a transmission of a respective signal to wake-up the wireless device 131, and a beginning of a respective paging occasion for the wireless device 131.

The determining in this Action 605 is based on the condition, e.g., a respective condition of the wireless device 131.

The respective signal to wake-up the wireless devices 131 may be, e.g., a Wake-Up Signal, WUS, PEI, or equivalent.

The condition is independent of whether or not the wireless device 131 uses discontinuous reception or extended discontinuous reception.

In some embodiments, the condition, e.g., the respective condition, may be one of the following.

According to a first option, the condition may be the respective type of the wireless device 131; the respective type may be, e.g., RedCap, non-RedCap.

According to a second option, the condition may be the first indication indicating the respective capability of the wireless device 131 to use the receiver to, e.g., specifically, receive the one or more respective signals to wake-up the one or more wireless devices 130, e.g., the wireless device 131, e.g., a WUR, and/or e.g., to use wake-up radio.

Action 501 may be performed in embodiments wherein the determining in this Action 504 of the respective duration of the time gap may be based on the correspondence between the respective capability of the one or more wireless devices 130 and the respective duration of the time gap.

According to a third option, the condition may be the respective duration of the time gap respectively supported by the wireless device 131.

According to a fourth option, the condition may be the respective first identity of the wireless device 131. The first identity may be, e.g., UE-ID.

According to a fifth option, the condition may be the second identity of the cell 120 wherein the wireless devices 131 may be located, at the time of the determining in this Action 605.

Determining in this Action 605 may comprise deciding, deriving or calculating autonomously, receiving from another node, or retrieving from a memory.

The indication received in Action 603 may respectively indicate the result of the determined respective duration of the time gap in this Action 605. In other words, the wireless device 131 may determine, in this Action 605, the respective duration to be that which the node 101 may have indicated to it in Action 603, as the node 101 may have itself determined in Action 504.

In some examples, the determining in Action 605 of the respective duration of the time gap may be based on the correspondence, e.g., a map or a table, between the respective capability of the wireless device 131 and the respective duration of the time gap.

The determining in this Action 605 of the respective duration of the time gap may be respectively based on the determined respective paging frame or paging occasion in Action 604.

### Action 606

In this Action 606, the wireless device 131 may determine the respective at least one of: search space, and random access occasion.

The determining in this Action 606 may be based on the determined respective duration of the time gap.

Determining in this Action 606 may comprise deciding, deriving or calculating autonomously, receiving from another node, or retrieving from a memory.

### Action 607

In this Action 607, the wireless device 131 receives the respective signal.

The receiving in this Action 607 of the respective signal is based on the determined respective duration. That is, the wireless device 131 may receive the respective signal from the node 101 using the respective duration of the time gap between the respective signal and the respective paging occasion.

The receiving in this Action 607 may be performed, e.g., via the first link 141, or the third link 143.

The receiving in this Action 607 of the of the respective signal may be based on at least one of the following.

According to the first option, the receiving in this Action 607 of the respective signal may be based on the wireless device 131 respectively supporting reception using the receiver to, e.g., specifically, receive the respective signal to wake-up the wireless device 131, e.g., a WUR or Wake-up receiver.

According to the second option, the receiving in this Action 607 of the respective signal may be based on the receiver to, e.g., specifically, receive the respective signal to wake-up the wireless device 131, e.g., a WUR, and/or e.g., wake-up radio, being supported in the cell 120 wherein the wireless device 131 may be located, e.g., at the time of the determining 605.

According to the third option, the receiving in this Action 607 of the respective signal may be based on the first configuration of the wireless device 131 for the receiver to, e.g., specifically, receive the one or more respective signals to wake-up the one or more wireless devices 130, e.g., WUR, matching the second configuration for the receiver, e.g., WUR, at the cell 120.

The wireless device 131 may monitor paging using WUS, e.g., monitor WUS before its PO, and only continue to monitor PDCCH in the PO, if and only if a) the wireless device 131 supports WUR according to the capabilities of the wireless device 131 earlier signaled to the network upon capability reporting of the one or more wireless devices 130 in Action 502, b) WUR is supported in the cell 120 according to acquired SI, and c) the WUR paging capability of the wireless device 131 fulfils the requirements of the WUR configuration used in the cell 120 according to SI (*). An example of condition c) may be that if the node 101 broadcasts that a maximum WUS time gap of 2s is used in the cell 120, the wireless device 131 may only use WUS for monitoring paging if the WUS time gap capability of the wireless device 131 is shorter than 2s. If all conditions are fulfilled, the wireless device 131 may monitor WUS with a time offset corresponding to the WUS time gap capability of the wireless device 131 before to PO, and only continue to monitor PDCCH in the PO if WUS is detected, if not, the wireless device 131 may go back to a sleep state.

### Keeping Legacy Paging Occasions

FIG. 7 is a schematic diagram depicting an illustration of WUS before legacy Paging Occasions. In a first group of examples, the wireless device 131 may keep its POs, e.g., as determined from UE_ID as specified in TS 38.304, v. 16.6.0, and WUS may be transmitted at a fixed time before the PO by the node 101 as e.g., network node 110, and monitored in the same time instant by the wireless device 131, e.g., see top part of FIG. 7. The node 101 as e.g., network node 110 may, upon reception, in Action 502, of the WUR capability of the wireless device 131, e.g., the minimum time gap required, in the ‘UE radio paging capabilities’ contained in the paging message from the Access and Mobility Management Function (AMF), be able to determine, in Action 504, which WUS time gap to apply for the wireless device 131 to ensure the wireless device 131 may use the WUR for detection of the WUS. Transmission of the WUS is represented as a striped box in FIG. 7. According to this, the node 101 may determine to use e.g., Time gap 1, or Time gap 2. Since many wireless devices 130 may share a given PO, the node 101 as e.g., network node 110 may have to transmit several WUSs before a PO, e.g., see bottom part of FIG. 7, wherein the node 101 transmits WUS both, with the Time gap 1 and Time gap 2 before the PO, during which the wireless device 131 may use its Main receiver, represented as a solid black box in FIG. 7.

### New Paging Occasion Mapping

In a second group of examples of embodiments herein, the one or more wireless devices 130 may instead be mapped to new POs depending on their WUS gap capability, instead of being mapped to POs according to the UE_IDs. In this way, wireless devices 130 using the same WUS time gap may be grouped to share POs such that the node 101 as e.g., network node 110, may at most have to transmit one WUS for a given PO, even when multiple UEs may be being paged. An example is shown in FIG. 8. FIG. 8 is a schematic diagram illustrating an example of a new mapping of WUR wireless devices 130 to Paging Occasions. Transmission of the WUS is represented as a striped box in FIG. 8. In the top row of FIG. 8, the node 101 transmits WUS with a first Time gap 1 before a first PO, during which the wireless device 131 may use its Main receiver, represented as a solid black box in FIG. 8. In the middle row, the node 101 transmits WUS with a second Time gap 2 before a second PO. In the bottom row, the node 101 transmits WUS with a third Time gap 3 before a third PO.

### General Considerations

Embodiments herein are above described for the case of WUS triggering the wireless device 131 to monitor PDCCH in the paging occasion, but may be generalized to apply to other UE actions upon WUS detection.

Embodiments herein are above described to be applied for downlink transmission from network node 110 to wireless device 131, but this may serve as an example and all embodiments may equally well apply also to uplink transmissions, e.g., WUR in base-station, or side-link transmission between wireless devices 131, e.g., from the another wireless device 132 as node 101, to the first wireless device 131.

The description above may be mainly for an NR system, but embodiments herein may be equally applicable to LTE, e.g., NB-IoT or LTE-M, or any 6G system.

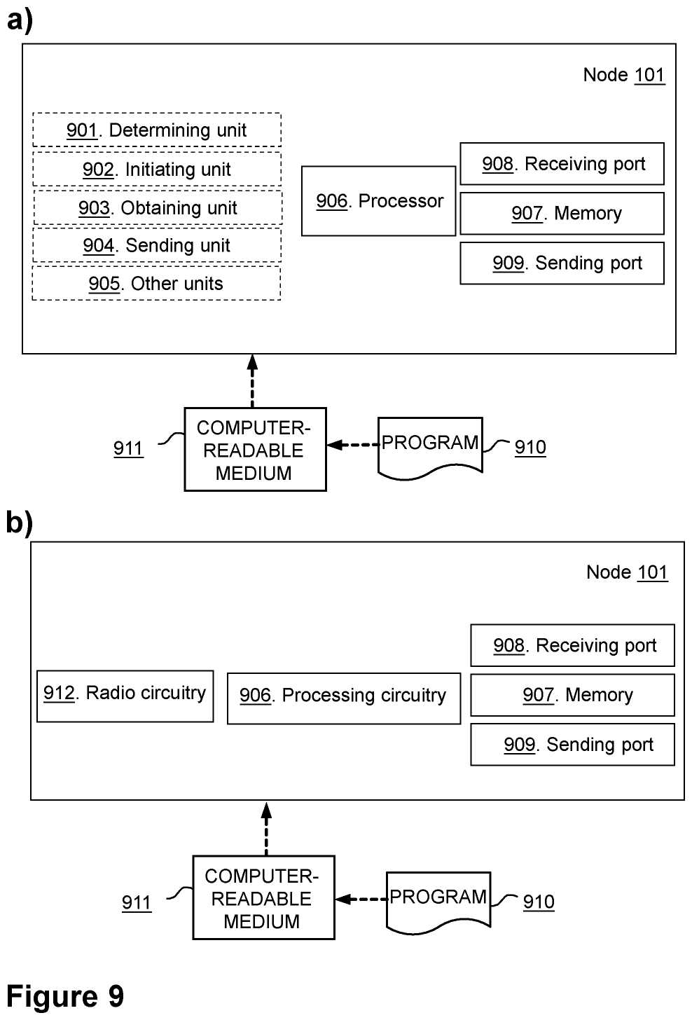

FIG. 9 depicts two different examples in panels a) and b), respectively, of the arrangement that the node 101 may comprise to perform the method actions described above in relation to FIG. 5, FIG. 7 and/or FIG. 8. In some embodiments, the node 101 may comprise the following arrangement depicted in FIG. 9a. The node 101 may be understood to be for handling the time gap. The node 101 is configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the node 101 and will thus not be repeated here. For example, the one or more signals to wake-up the one or more wireless devices 130 may be configured to be, e.g., Wake-Up Signals, WUSs, PEI, or equivalent.

In FIG. 9, optional units are indicated with dashed boxes.

The node 101 is configured to perform the determining of Action 504, e.g. by means of a determining unit 901 within the node 101, configured to, determine the respective duration of the time gap between the transmission of the one or more respective signals to wake-up the one or more wireless devices 130 configured to operate in the wireless communications network 100 and the beginning of the one or more respective paging occasions. The determining is configured to be based on the condition. The condition is configured to be independent of whether or not the one or more wireless devices 130 are configured to use discontinuous reception or extended discontinuous reception.

The node 101 is also configured to perform the initiating of Action 507, e.g. by means of an initiating unit 902 within the node 101, configured to, initiate the transmission of the one or more respective signals to the one or more wireless devices 130 based on the respective duration configured to be determined.

In some embodiments, the condition may be configured to be one of: i) the respective type of the one or more wireless devices 130, ii) the first indication configured to indicate the respective capability of the one or more wireless devices 130 to use the receiver to receive the one or more respective signals to wake-up the one or more wireless devices 130, iii) the respective duration of the time gap configured to be respectively supported by the one or more wireless devices 130, iv) the respective first identity of the one or more wireless devices 130, and v) the second identity of the cell 120 wherein the one or more wireless devices 130 may be configured to be respectively located.

In some embodiments, the node 101 may be configured to perform the obtaining of Action 502, e.g. by means of an obtaining unit 903 within the node 101, configured to obtain the first indication configured to indicate the respective capability of the one or more wireless devices 130 to use the receiver to receive the one or more respective signals to wake-up the one or more wireless devices 130, supporting one time gap or the plurality of time gaps.

In some embodiments, the node 101 may be configured to perform the sending of Action 506, e.g. by means of a sending unit 904, configured to send the one or more indications towards the one or more wireless devices 130. The one or more indications may be configured to respectively indicate the result of the respective duration of the time gap configured to be determined.

In some embodiments, the initiating of the transmission of the one or more respective signals to the one or more wireless devices 130 may be configured to be based on at least one of: i) the one or more wireless devices 130 being configured to respectively support reception using the receiver to receive the one or more respective signals to wake-up the one or more wireless devices 130, ii) WUR being configured to be supported in the cell 120 wherein the one or more wireless devices 130 may be respectively located, and iii) the first configuration of the respective wireless device 131 for the receiver to receive the one or more respective signals to wake-up the one or more wireless devices 130, matching the second configuration for the receiver at the cell 120.

In some embodiments, the node 101 may be configured to perform the determining of Action 503, e.g. by means of the determining unit 901 within the node 101, configured to determine which respective paging frame or paging occasion to use for the one or more wireless devices 130, out of the plurality of paging frames or paging occasions. The determining of the respective duration of the time gap may be respectively configured to be based on the respective paging frame or paging occasion configured to be determined.

In some embodiments, the node 101 may be configured to perform the determining of Action 505, e.g. by means of the determining unit 901 within the node 101, configured to determine, based on the respective duration of the time gap configured to be determined, the respective at least one of: search space, and random access occasion.

In some embodiments wherein the determining of the respective duration of the time gap may be configured to be based on the correspondence between the respective capability of the one or more wireless devices 130 and the respective duration of the time gap, the node 101 may be configured to perform the sending of Action 501, e.g. by means of the sending unit 904, configured to send the respective previous indication to the one or more wireless devices 130. The respective previous indication may be configured to indicate the correspondence.

In some embodiments, the node 101 may be configured to be one of: the network node 110, the core network node 125, and the another wireless device 132.

Other units 905 may be comprised in the node 101.

The embodiments herein in the node 101 may be implemented through one or more processors, such as a processor 906 in the node 101 depicted in FIG. 9a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the node 101. One such carrier may be in the form of a CD ROM disc. It is however feasible with other data carriers such as a memory stick. The computer program code may furthermore be provided as pure program code on a server and downloaded to the node 101.

The node 101 may further comprise a memory 907 comprising one or more memory units. The memory 907 is arranged to be used to store obtained information, store data, configurations, schedulings, and applications etc. to perform the methods herein when being executed in the node 101.

In some embodiments, the node 101 may receive information from, e.g., the one or more wireless devices 130, the wireless device 131, the another wireless device 132, the core network node 125, and/or the network node 110, through a receiving port 908. In some embodiments, the receiving port 908 may be, for example, connected to one or more antennas in node 101. In other embodiments, the node 101 may receive information from another structure in the wireless communications network 100 through the receiving port 908. Since the receiving port 908 may be in communication with the processor 906, the receiving port 908 may then send the received information to the processor 906. The receiving port 908 may also be configured to receive other information.

The processor 906 in the node 101 may be further configured to transmit or send information to e.g., the one or more wireless devices 130, the wireless device 131, the another wireless device 132, the core network node 125, the network node 110, and/or another structure in the wireless communications network 100, through a sending port 909, which may be in communication with the processor 906, and the memory 907.

Those skilled in the art will also appreciate that the different units 901-905 described above may refer to a combination of analog and digital modules, and/or one or more processors configured with software and/or firmware, e.g., stored in memory, that, when executed by the one or more processors such as the processor 906, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 901-905 described above may be implemented as one or more applications running on one or more processors such as the processor 906.

Thus, the methods according to the embodiments described herein for the node 101 may be respectively implemented by means of a computer program 910 product, comprising instructions, i.e., software code portions, which, when executed on at least one processor 906, cause the at least one processor 906 to carry out the actions described herein, as performed by the node 101. The computer program 910 product may be stored on a computer-readable storage medium 911. The computer-readable storage medium 911, having stored thereon the computer program 910, may comprise instructions which, when executed on at least one processor 906, cause the at least one processor 906 to carry out the actions described herein, as performed by the node 101. In some embodiments, the computer-readable storage medium 911 may be a non-transitory computer-readable storage medium, such as a CD ROM disc, or a memory stick. In other embodiments, the computer program 910 product may be stored on a carrier containing the computer program 910 just described, wherein the carrier is one of an electronic signal, optical signal, radio signal, or the computer-readable storage medium 911, as described above.

The node 101 may comprise a communication interface configured to facilitate communications between the node 101 and other nodes or devices, e.g., the one or more wireless devices 130, the wireless device 131, the another wireless device 132, the core network node 125, the network node 110 and/or another structure in the wireless communications network 100. The interface may, for example, include a transceiver configured to transmit and receive radio signals over an air interface in accordance with a suitable standard.

In other embodiments, the node 101 may comprise the following arrangement depicted in FIG. 9b. The node 101 may comprise a processing circuitry 906, e.g., one or more processors such as the processor 906, in the node 101 and the memory 907. The node 101 may also comprise a radio circuitry 912, which may comprise e.g., the receiving port 908 and the sending port 909. The processing circuitry 906 may be configured to, or operable to, perform the method actions according to FIG. 5, FIG. 7 and/or FIG. 8, in a similar manner as that described in relation to FIG. 9a. The radio circuitry 912 may be configured to set up and maintain at least a wireless connection with the one or more wireless devices 130, the wireless device 131, the another wireless device 132, the core network node 125, the network node 110 and/or another structure in the wireless communications network 100. Circuitry may be understood herein as a hardware component.

Hence, embodiments herein also relate to the node 101 comprising the processing circuitry 906 and the memory 907, said memory 907 containing instructions executable by said processing circuitry 906, whereby the node 101 is operative to perform the actions described herein in relation to the node 101, e.g., in FIG. 5, FIG. 7 and/or FIG. 8.

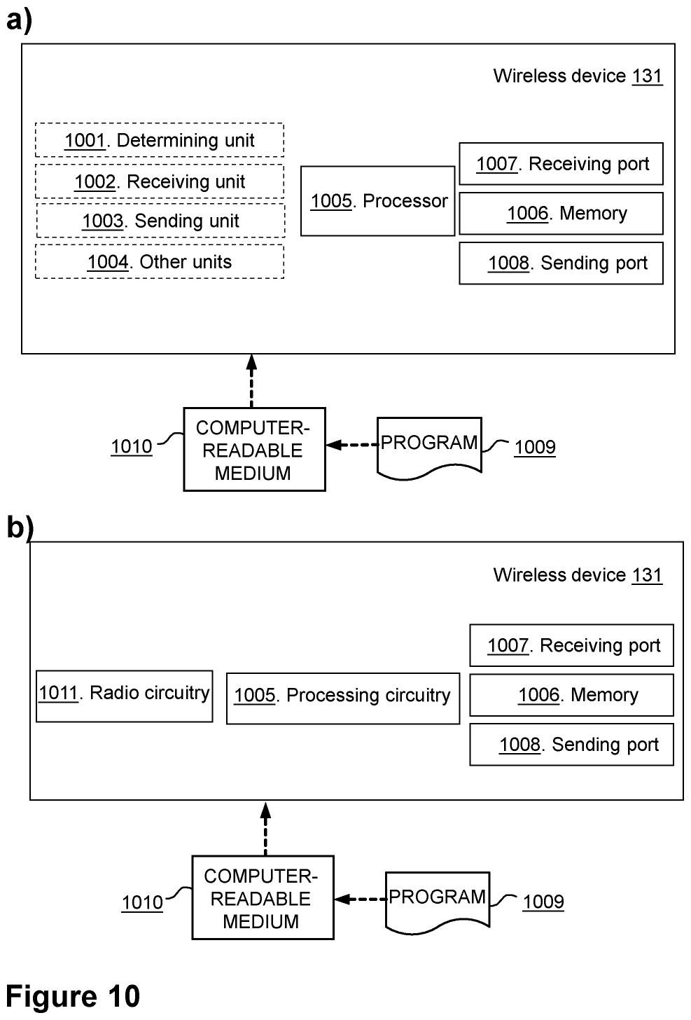

FIG. 10 depicts two different examples in panels a) and b), respectively, of the arrangement that the wireless device 131 may comprise to perform the method actions described above in relation to FIG. 6, FIG. 7 and/or FIG. 8. In some embodiments, the wireless device 131 may comprise the following arrangement depicted in FIG. 10a. The wireless device 131 may be understood to be for handling the time gap. The wireless device 131 is configured to operate in the wireless communications network 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the wireless device 131 and will thus not be repeated here. For example, the downlink signal to wake-up the wireless device 131 may be, e.g., a WUS.

In FIG. 10, optional units are indicated with dashed boxes.

The wireless device 131 is configured to perform the determining of Action 605, e.g. by means of a determining unit 1001 within the wireless device 131, configured to determine the respective duration of the time gap between the transmission of the respective signal to wake-up the wireless device 131, and the beginning of the respective paging occasion for the wireless device 131. The determining is configured to be based on the condition. The condition is configured to be independent of whether or not the wireless device 131 uses discontinuous reception or extended discontinuous reception.

The wireless device 131 is configured to perform the receiving of Action 607, e.g. by means of a receiving unit 1002 within the wireless device 131, configured to receive the respective signal based on the respective duration configured to be determined.

In some embodiments, the condition may be configured to be one of: i) the respective type of the wireless device 131, ii) the first indication configured to indicate the respective capability of the wireless device 131 to use the receiver to receive the one or more respective signals to wake-up the one or more wireless devices 130, iii) the respective duration of the time gap configured to be respectively supported by the wireless device 131, iv) the respective first identity of the wireless device 131, and v) the second identity of the cell 120 wherein the wireless device 131 may be configured to be located.

In some embodiments, the wireless device 131 may be configured to perform the obtaining of Action 602, e.g. by means of a sending unit 1003 comprised in the wireless device 131, configured to send the first indication. The first indication is configured to indicate the respective capability of the wireless device 131 to use the receiver to receive the one or more respective signals to wake-up the one or more wireless devices 130, supporting one time gap or the plurality of time gaps.

In some embodiments, the wireless device 131 may be configured to perform the receiving of Action 603, e.g. by means of the receiving unit 1002 within the wireless device 131, configured to receive the indication from the node 101 configured to operate in the wireless communications network 100. The indication is configured to respectively indicate the result of the respective duration of the time gap configured to be determined.

In some embodiments, the receiving of the of the respective signal may be configured to be based on at least one of: i) the wireless device 131 being configured to respectively support reception using the receiver to receive the respective signal to wake-up the wireless device 131, ii) the receiver configured to receive the respective signal to wake-up the wireless device 131 being configured to be supported in the cell 120 wherein the wireless device 131 is located, and iii) the first configuration of the wireless device 131 for the receiver matching the second configuration for the receiver at the cell 120.

In some embodiments, the wireless device 131 may be configured to perform the determining of Action 604, e.g. by means of the determining unit 1001 within the wireless device 131, configured to determine which respective paging frame or paging occasion to use, out of the plurality of paging frames or paging occasions. The determining of the respective duration of the time gap may be configured to be respectively based on the respective paging frame or paging occasion configured to be determined.

In some embodiments, the wireless device 131 may be configured to perform the determining of Action 606, e.g. by means of the determining unit 1001 within the wireless device 131, configured to determine, based on the respective duration of the time gap configured to be determined, the respective at least one of: search space, and random access occasion.

In some embodiments wherein the determining of the respective duration of the time gap may be configured to be based on the correspondence between the respective capability of the wireless device 131 and the respective duration of the time gap, the wireless device 131 may be configured to perform the receiving of Action 601, e.g. by means of the receiving unit 1002 within the wireless device 131, configured to receive the respective previous indication from the node 101, the respective previous indication being configured to indicate the correspondence. In some embodiments, the node 101 may be configured to be one of: the network node 110, the core network node 125, and the another wireless device 132.

Other units 1004 may be comprised in the wireless device 131.

The embodiments herein in the wireless device 131 may be implemented through one or more processors, such as a processor 1005 in the wireless device 131 depicted in FIG. 10a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the wireless device 131. One such carrier may be in the form of a CD ROM disc. It is however feasible with other data carriers such as a memory stick. The computer program code may furthermore be provided as pure program code on a server and downloaded to the wireless device 131.

The wireless device 131 may further comprise a memory 1006 comprising one or more memory units. The memory 1006 is arranged to be used to store obtained information, store data, configurations, schedulings, and applications etc. to perform the methods herein when being executed in the wireless device 131.

In some embodiments, the wireless device 131 may receive information from, e.g., the node 101, the another wireless device 132, any of the other wireless devices of the one or more wireless devices 130, the core network node 125, and/or the network node 110, through a receiving port 1007. In some embodiments, the receiving port 1007 may be, for example, connected to one or more antennas in wireless device 131. In other embodiments, the wireless device 131 may receive information from another structure in the wireless communications network 100 through the receiving port 1007. Since the receiving port 1007 may be in communication with the processor 1005, the receiving port 1007 may then send the received information to the processor 1005. The receiving port 1007 may also be configured to receive other information.

The processor 1005 in the wireless device 131 may be further configured to transmit or send information to e.g., the node 101, the another wireless device 132, any of the other wireless devices of the one or more wireless devices 130, the core network node 125, the network node 110, and/or or another structure in the wireless communications network 100, through a sending port 1008, which may be in communication with the processor 1005, and the memory 1006.

Those skilled in the art will also appreciate that the different units 1001-1004 described above may refer to a combination of analog and digital modules, and/or one or more processors configured with software and/or firmware, e.g., stored in memory, that, when executed by the one or more processors such as the processor 1005, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1001-1004 described above may be implemented as one or more applications running on one or more processors such as the processor 1005.

Thus, the methods according to the embodiments described herein for the wireless device 131 may be respectively implemented by means of a computer program 1009 product, comprising instructions, i.e., software code portions, which, when executed on at least one processor 1005, cause the at least one processor 1005 to carry out the actions described herein, as performed by the wireless device 131. The computer program 1009 product may be stored on a computer-readable storage medium 101. The computer-readable storage medium 101, having stored thereon the computer program 1009, may comprise instructions which, when executed on at least one processor 1005, cause the at least one processor 1005 to carry out the actions described herein, as performed by the wireless device 131. In some embodiments, the computer-readable storage medium 101 may be a non-transitory computer-readable storage medium, such as a CD ROM disc, or a memory stick. In other embodiments, the computer program 1009 product may be stored on a carrier containing the computer program 1009 just described, wherein the carrier is one of an electronic signal, optical signal, radio signal, or the computer-readable storage medium 101, as described above.

The wireless device 131 may comprise a communication interface configured to facilitate communications between the wireless device 131 and other nodes or devices, e.g., the node 101, the another wireless device 132, any of the other wireless devices of the one or more wireless devices 130, the core network node 125, the network node 110 and/or another structure in the wireless communications network 100. The interface may, for example, include a transceiver configured to transmit and receive radio signals over an air interface in accordance with a suitable standard.

In other embodiments, the wireless device 131 may comprise the following arrangement depicted in FIG. 10b. The wireless device 131 may comprise a processing circuitry 1005, e.g., one or more processors such as the processor 1005, in the wireless device 131 and the memory 1006. The wireless device 131 may also comprise a radio circuitry 1011, which may comprise e.g., the receiving port 1007 and the sending port 1008. The processing circuitry 1011 may be configured to, or operable to, perform the method actions according to FIG. 6, FIG. 7 and/or FIG. 8, in a similar manner as that described in relation to FIG. 10a. The radio circuitry 1011 may be configured to set up and maintain at least a wireless connection with the node 101, the another wireless device 132, any of the other wireless devices of the one or more wireless devices 130, the core network node 125, the network node 110 and/or another structure in the wireless communications network 100. Circuitry may be understood herein as a hardware component.

Hence, embodiments herein also relate to the wireless device 131 comprising the processing circuitry 1005 and the memory 1006, said memory 1006 containing instructions executable by said processing circuitry 1005, whereby the wireless device 131 is operative to perform the actions described herein in relation to the wireless device 131, e.g., in FIG. 6, FIG. 7 and/or FIG. 8.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

EXAMPLES of, or related to, embodiments herein Examples related to embodiments herein may be as follows.

The node 101 embodiments relate to FIG. 5, FIG. 7, FIG. 8, FIG. 9 and FIGS. 11-16.

A method, performed by a node, such as the node 101 is described herein. The method may be understood to be for handling a time gap. The node 101 may be operating in a wireless communications network, such as the wireless communications network 100.

The node 101 may be one of: the network node 110, the core network node 125, and the another wireless device 132.

In some embodiments, the wireless communications network 100 may support at least one of: New Radio (NR), Long Term Evolution (LTE), LTE for Machines (LTE-M), enhanced Machine Type Communication (eMTC), IoT and Narrow Band Internet of Things (NB-IoT).

The method may comprise one or more of the following actions. In some embodiments, all the actions may be performed. In some embodiments, two actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the node 101 is depicted in FIG. 5. In FIG. 5, optional actions in some embodiments may be represented with dashed lines.
Determining 504 a respective duration of a time gap. The node 101 may be configured to perform this determining action 504, e.g. by means of a determining unit 901 within the node 101, configured to perform this action.

The time gap may be between a transmission of one or more respective signals to wake-up one or more wireless devices 130 operating in the wireless communications network 100, and a beginning of a one or more respective paging occasions.

The one or more respective signals to wake-up the one or more wireless devices 130 may be, e.g., Wake-Up Signals, WUSs, PEI, or equivalent.

The determining 504 in this Action may be based on a condition.

In some embodiments, the condition may be independent of whether or not the one or more wireless devices 130 use discontinuous reception or extended discontinuous reception.

The condition may be one of:
a respective type of the one or more wireless devices 130; the respective type may be, e.g., RedCap, non-RedCap,
a first indication indicating a respective capability of the one or more wireless devices 130 e.g., to use a receiver to, e.g., specifically, receive the one or more respective signals to wake-up the one or more wireless devices 130, e.g., a WUR, and/or e.g., to use wake-up radio.
a respective duration of the time gap respectively supported by the one or more wireless devices 130,
a respective first identity of the one or more wireless devices 130, and
a second identity of a cell 120 wherein the one or more devices 130 are respectively located, e.g., at the time of the determining 504.

Determining in this Action 502 may comprise deciding, deriving or calculating autonomously, receiving from another node, or retrieving from a memory.
Initiating 507 transmission of the one or more respective signals to the one or more wireless devices 130. The node 101 may be configured to perform this initiating Action 507, e.g. by means of an initiating unit 902 within the node 101, configured to perform this action.

Transmitting may be, e.g., sending.

Initiating may be understood as triggering, enabling, facilitating or starting. For example, in examples wherein the node 101 may be the core network node 125, the node 101 may enable the network node 110 to perform the transmission, e.g., via the first link 141. In examples wherein the node 101 may be the network node 110 or the another wireless device 132, the node 101 may start performing the transmission, e.g., via the first link 141 or the third link 143, respectively.

The initiating transmission in this Action 507 of the one or more respective signals to the one or more wireless devices 130, may be based on the determined respective duration.

In some examples, the initiating in this Action 507 of the transmission of the one or more respective signals to the one or more wireless devices 130 may be based on at least one of:
i. the one or more wireless devices 130 respectively supporting reception using the receiver to, e.g., specifically, receive the one or more respective signals to wake-up the one or more wireless devices 130, e.g., a WUR Wake-up receiver,
ii. a receiver to, e.g., specifically, receive the one or more respective signals to wake-up the one or more wireless devices 130, e.g., a WUR, and/or e.g., wake-up radio being supported in the cell 120 wherein the one or more wireless devices 130 may be respectively located, e.g., at the time of the determining 504, and
iii. a first configuration of a respective wireless device 131 for the receiver to, e.g., specifically, receive the one or more respective signals to wake-up the one or more wireless devices 130, e.g., WUR, matching a second configuration for the receiver, e.g., WUR at the cell 120.

In some embodiments, the method may further comprise one or more of the following actions:
Obtaining 502 the first indication. The node 101 may be configured to perform this obtaining action 502, e.g. by means of an obtaining unit 903 within the node 101, configured to perform this action.

Obtaining may be receiving from another node, or retrieving from a memory.

The obtaining, e.g., receiving, in this Action 502 may be from the one or more wireless devices 130. This may be directly or indirectly.

The first indication may indicate the respective capability of the one or more wireless devices 130. The respective capability of the one or more wireless devices 130 may be to use the receiver to, e.g., specifically, receive the one or more respective signals to wake-up the one or more wireless devices 130, e.g., a WUR, e.g., supporting one time gap or a plurality of time gaps.
Sending 506 one or more indications. The node 101 may be configured to perform this sending action 506, e.g. by means of a sending unit 904, configured to perform this action.

The sending in this Action 506 may be towards the one or more wireless devices 130. Towards may be understood to mean directly, e.g., from the network node 110, or indirectly, e.g., from the core network node 125.

The one or more indications may respectively indicate a result of the determined respective duration of the time gap.

The sending in this Action 506 may be performed via at least one of: Radio Resource Control (RRC) signalling, via System Information (SI) and via NAS signalling. The sending via RRC or SI may be performed in examples wherein the node 101 may be the network node 110.

The sending via NAS signalling may be performed in examples wherein the node 101 may be the core network node 125. In other examples, wherein the node 101 may be the another wireless device 132, the sending in this Action 501 may be performed via a SL, e.g., D2D communication.
Determining 503 which respective paging frame or paging occasion to use for the one or more wireless devices 130, out of a plurality of paging frames or paging occasions. The node 101 may be configured to perform this determining action 503, e.g. by means of the determining unit 901 within the node 101, configured to perform this action.

The determining 504 of the respective duration of the time gap may be respectively based on the determined respective paging frame or paging occasion.

Determining in this Action 503 may comprise deciding, deriving or calculating autonomously, receiving from another node, or retrieving from a memory.
Determining 505 a respective at least one of: search space, and random access occasion. The node 101 may be configured to perform this determining action 505, e.g. by means of the determining unit 901 within the node 101, configured to perform this action.

The determining in this Action 505 may be based on the determined respective duration of the time gap.

Determining in this Action 505 may comprise deciding, deriving or calculating autonomously, receiving from another node, or retrieving from a memory.
Sending 501 a respective previous indication. The node 101 may be configured to perform this sending action 501, e.g. by means of the sending unit 904, configured to perform this action.

The sending in this Action 501 of the respective previous indication may be to the one or more wireless devices 130.

In some examples, the determining in Action 504 of the respective duration of the time gap may be based on a correspondence, e.g., a map or a table. The correspondence may be between the respective capability of the one or more wireless devices 130 and the respective duration of the time gap.

The respective previous indication may indicate the correspondence.

The sending in this Action 501 may be performed via at least one of: Radio Resource Control (RRC) signalling, via System Information (SI) and via NAS signalling. The sending via RRC or SI may be performed in examples wherein the node 101 may be the network node 110. The sending via NAS signalling may be performed in examples wherein the node 101 may be the core network node 125. In other examples, wherein the node 101 may be the another wireless device 132, the sending in this Action 501 may be performed via a SL, e.g., D2D communication.

Other units 905 may be comprised in the node 101.

The node 101 may also be configured to communicate user data with a host application unit in a host computer 1210, e.g., via another link such as 1260.

In FIG. 9, optional units are indicated with dashed boxes.

The node 101 may comprise an interface unit to facilitate communications between the node 101 and other nodes or devices, e.g., the one or more wireless device 130, the wireless device 131, the network node 110, the host computer 1210, or any of the other nodes. In some particular examples, the interface may, for example, include a transceiver configured to transmit and receive radio signals over an air interface in accordance with a suitable standard.

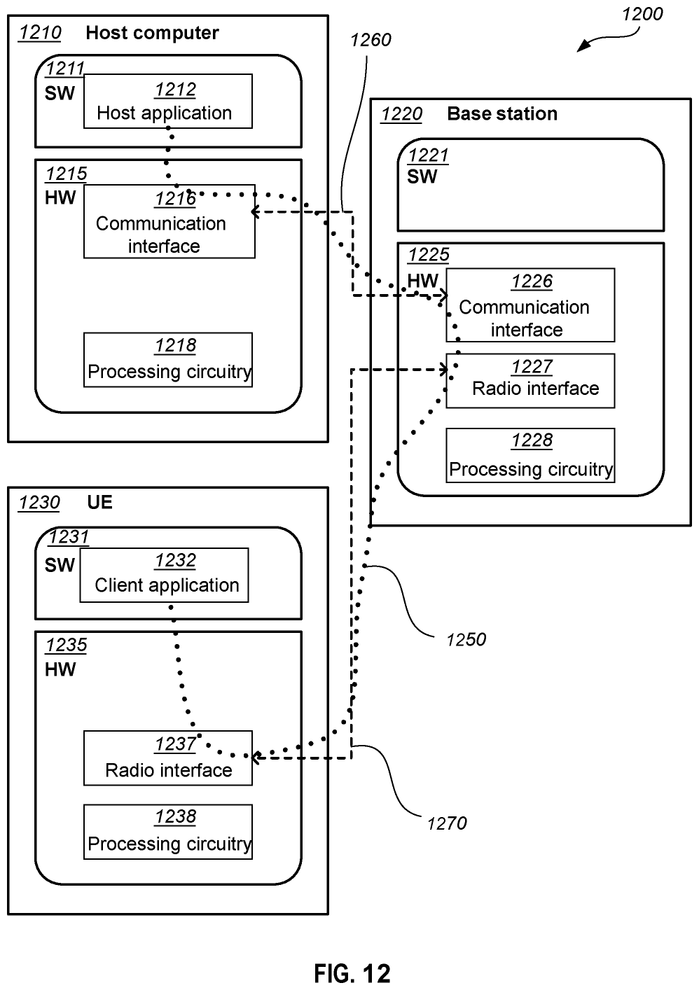

The node 101 may comprise an arrangement as shown in FIG. 9 or in FIG. 12.

The wireless device 131 embodiments relate to FIG. 6, FIG. 7, FIG. 8, FIG. 10 and FIGS. 11-16.

A method, performed by a wireless device, such as the wireless device 131 is described herein. The method may be understood to be for handling a time gap. The wireless device 131 may be operating in a wireless communications network, such as the wireless communications network 100.

In some embodiments, the wireless communications network 100 may support at least one of: New Radio (NR), Long Term Evolution (LTE), LTE for Machines (LTE-M), enhanced Machine Type Communication (eMTC), IoT and Narrow Band Internet of Things (NB-IoT).

The method may comprise one or more of the following actions. In some embodiments, all the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the wireless device 131 is depicted in FIG. 6. In FIG. 6, optional actions in some embodiments may be represented with dashed lines.

The detailed description of some of the following corresponds to the same references provided above, in relation to the actions described for the node 101 and will thus not be repeated here to simplify the description. For example, the one or more signals to wake-up the one or more wireless devices 130 may be, e.g., Wake-Up Signals, WUSs, PEI, or equivalent.
Determining 605 the respective duration of the time gap. The wireless device 131 may be configured to perform this determining action 605, e.g. by means of a determining unit 1001 within the wireless device 131, configured to perform this action.

The time gap may be between a transmission of a respective signal to wake-up the wireless device 131, and a beginning of a respective paging occasion for the wireless device 131.

The determining in this Action 605 may be based on a condition, e.g., a respective condition of the wireless device 131.

The respective signal to wake-up the wireless devices 131 may be, e.g., a Wake-Up Signal, WUS, PEI, or equivalent.

In some embodiments, the condition may be independent of whether or not the wireless device 131 may use discontinuous reception or extended discontinuous reception.

The condition, e.g., the respective condition, may be one of:
the respective type of the wireless device 131; the respective type may be, e.g., RedCap, non-RedCap,
the first indication indicating the respective capability of the wireless device 131 to e.g., use the receiver to, e.g., specifically, receive the one or more respective signals to wake-up the one or more wireless devices 130, e.g., the wireless device 131, e.g., the WUR and/or e.g., to use wake-up radio,
the respective duration of the time gap respectively supported by the wireless device 131,
the respective first identity of the wireless device 131, and
the second identity of the cell 120 wherein the wireless device 131 may be located, e.g., at the time of the determining 605.

Determining in this Action 605 may comprise deciding, deriving or calculating autonomously, receiving from another node, or retrieving from a memory.
Receiving 607 the respective signal. The wireless device 131 may be configured to perform this receiving action 607, e.g. by means of a receiving unit 1002 within the wireless device 131, configured to perform this action.

The receiving in this Action 607 of the respective signal may be based on the determined respective duration.

The receiving in this Action 607 may be performed, e.g., via the first link 141, or the third link 143.

In some embodiments, the method may further comprise one or more of the following actions:
Sending 602 the first indication. The wireless device 131 may be configured to perform this obtaining action 602, e.g. by means of an obtaining unit 1003 comprised in the wireless device 131, configured to perform this action.

Obtaining may be receiving from another node, or retrieving from a memory.

The sending in this Action 602 may be to the node 101. This may be directly, e.g., to the network node 110 or to the another wireless device 132, or indirectly, e.g., via the network node 110 to the core network node 125.

The first indication may indicate the respective capability of the wireless device 131. The respective capability of the wireless device 131 may be to use the receiver to, e.g., specifically, receive the one or more respective signals to wake-up the one or more wireless devices 130, e.g., the wireless device 131, e.g., a WUR, e.g., supporting one time gap or a plurality of time gaps.

The receiver to, e.g., specifically, receive the one or more respective signals to wake-up the one or more wireless devices 130 may be understood to refer to the type of signals in a generic way, e.g., WUS, and not to mean that the receiver may have to be able to receive all the signals, to all of the one or more wireless devices 130, e.g., all the WUSs.

In some embodiments, the method may further comprise one or more of the following actions:
Receiving 603 an indication. The wireless device 131 may be configured to perform this receiving action 603, e.g. by means of the receiving unit 1002 within the wireless device 131, configured to perform this action.

The receiving in this Action 603 may be from the node 101 operating in the wireless communications network 100, directly, e.g., from the network node 110, or indirectly, e.g., from the core network node 125.

The node 101 may be one of: the network node 110, the core network node 125, and the another wireless device 132.

The indication may respectively indicate a result of the determined respective duration of the time gap.

The receiving in this Action 607 of the of the respective signal may be based on at least one of:
i. the wireless device 131 respectively supporting reception using the receiver to, e.g., specifically, receive the one or more respective signals to wake-up the one or more wireless devices 130, e.g., a WUR or Wake-up receiver,
ii. a receiver to, e.g., specifically, receive the one or more respective signals to wake-up the one or more wireless devices 130, e.g., a WUR, and/or e.g., wake-up radio being supported in the cell 120 wherein the wireless device 131 may be located, e.g., at the time of the determining 605, and
iii. a first configuration of the wireless device 131 for the receiver, e.g., WUR, matching the second configuration for the receiver, e.g., WUR, at the cell 120.
   Determining 604 which respective paging frame or paging occasion to use, out of the plurality of paging frames or paging occasions. The wireless device 131 may be configured to perform this determining action 604, e.g. by means of the determining unit 1001 within the wireless device 131, configured to perform this action.

The determining 604 of the respective duration of the time gap may be respectively based on the determined respective paging frame or paging occasion.

Determining in this Action 604 may comprise deciding, deriving or calculating autonomously, receiving from another node, or retrieving from a memory.
Determining 606 a respective at least one of: search space, and random access occasion. The wireless device 131 may be configured to perform this determining action 606, e.g. by means of the determining unit 1001 within the wireless device 131, configured to perform this action.

The determining in this Action 606 may be based on the determined respective duration of the time gap.

Determining in this Action 606 may comprise deciding, deriving or calculating autonomously, receiving from another node, or retrieving from a memory.
Receiving 601 a respective previous indication. The wireless device 131 may be configured to perform this receiving action 601, e.g. by means of the receiving unit 1002 within the wireless device 131, configured to perform this action.

The receiving in this Action 603 may be from the node 101.

In some examples, the determining in Action 605 of the respective duration of the time gap may be based on a correspondence, e.g., a map or a table. The correspondence may be between the respective capability of the wireless device 131 and the respective duration of the time gap.

The respective previous indication may indicate the correspondence.

The receiving in in any of Action 601 and/or Action 603 may be performed via at least one of: Radio Resource Control (RRC) signalling, via System Information (SI) and via NAS signalling. The receiving via RRC or SI may be performed in examples wherein the node 101 may be the network node 110. The receiving via NAS signalling may be performed in examples wherein the node 101 may be the core network node 125. In other examples, wherein the node 101 may be the another wireless device 132, the receiving in any of Action 601 and/or Action 603 may be performed via a SL, e.g., D2D communication.

Other units 1004 may be comprised in the wireless device 131.

The wireless device 131 may also be configured to communicate user data with a host application unit in a host computer 1210, e.g., via another link such as 1260.

In FIG. 10, optional units are indicated with dashed boxes.

The wireless device 131 may comprise an interface unit to facilitate communications between the wireless device 131 and other nodes or devices, e.g., the node 101, the network node 110, the core network node 125, the another wireless device 132, any of the other one or more wireless devices 130, the host computer 1210, or any of the other nodes. In some particular examples, the interface may, for example, include a transceiver configured to transmit and receive radio signals over an air interface in accordance with a suitable standard.

The wireless device 131 may comprise an arrangement as shown in FIG. 10 or in

FIG. 12.

Numbered examples related to embodiments herein:

Example 1. A method performed by a node (101), the method being for handling a time gap, the node (101) operating in a wireless communications network (100), and the method comprising:
determining (504) a respective duration of a time gap between a transmission of one or more respective signals to wake-up one or more wireless devices (130) operating in the wireless communications network (100), e.g., Wake-Up signals, WUS, and a beginning of a one or more respective paging occasions, the determining (504) being based on a condition, and
initiating (507) transmission of the one or more respective signals to the one or more wireless devices (130) based on the determined respective duration.

Example 2. The method according to example 1, wherein the condition is independent of whether or not the one or more wireless devices (130) use discontinuous reception or extended discontinuous reception.

Example 3. The method according to any of examples 1-2, wherein the condition is one of:
a respective type of the one or more wireless devices (130),
a first indication indicating a respective capability of the one or more wireless devices (130) to use a receiver to, e.g., specifically, receive the one or more respective signals to wake-up the one or more wireless devices 130, e.g., a WUR,
a respective duration of the time gap respectively supported by the one or more wireless devices (130),
a respective first identity of the one or more wireless devices (130), and
a second identity of a cell (120) wherein the one or more devices (130) are respectively located, e.g., at the time of the determining (504).

Example 4. The method according to example 3, further comprising:
obtaining (502) the first indication indicating the respective capability of the one or more wireless devices (130) to use the receiver to, e.g., specifically, receive the one or more respective signals to wake-up the one or more wireless devices 130, e.g., a WUR, supporting one time gap or a plurality of time gaps.

Example 5. The method according to any of examples 1-4, further comprising:
sending (506) one or more indications towards the one or more wireless devices (130), the one or more indications respectively indicating a result of the determined respective duration of the time gap.

Example 6. The method according to any of examples 1-5, wherein the initiating (507) of the transmission of the one or more respective signals to the one or more wireless devices (130) is based on at least one of:
i. the one or more wireless devices (130) respectively supporting reception using a receiver to, e.g., specifically, receive the one or more respective signals to wake-up the one or more wireless devices 130, e.g., a WUR Wake-up receiver,
ii. WUR being supported in a cell (120) wherein the one or more wireless devices (130) are respectively located, e.g., at the time of the determining (504), and
iii. a first configuration of a respective wireless device (131) for the receiver to, e.g., specifically, receive the one or more respective signals to wake-up the one or more wireless devices 130, e.g., WUR, matching a second configuration for the receiver, e.g., WUR at the cell (120).

Example 7. The method according to any of examples 1-6, further comprising at least one of:
determining (503) which respective paging frame or paging occasion to use for the one or more wireless devices (130), out of a plurality of paging frames or paging occasions, and wherein the determining (504) of the respective duration of the time gap is respectively based on the determined respective paging frame or paging occasion, and
determining (505), based on the determined respective duration of the time gap, a respective at least one of: search space, and random access occasion.

Example 8. The method according to example 4, wherein the determining (504) of the respective duration of the time gap is based on a correspondence between the respective capability of the one or more wireless devices (130) and the respective duration of the time gap, and wherein the method further comprises:
sending (501) a respective previous indication to the one or more wireless devices (130), the respective previous indication indicating the correspondence.

Example 9. The method according to any of examples 1-8, wherein the node (101) is one of: a network node (110), a core network node (125), and another wireless device (132).

Example 10. A method performed by a wireless device (131), the method being for handling a time gap, the wireless device (131) operating in a wireless communications network (100), and the method comprising:
determining (605) a respective duration of a time gap between a transmission of a respective signal to wake-up the wireless device (131), and a beginning of a respective paging occasion for the wireless device (131), the determining (605) being based on a condition, and
receiving (607) the respective signal based on the determined respective duration.

Example 11. The method according to example 10, wherein the condition is independent of whether or not the wireless device (131) uses discontinuous reception or extended discontinuous reception.

Example 12. The method according to any of examples 10-11, wherein the condition is one of:
a respective type of the wireless device (131),
a first indication indicating a respective capability of the wireless device (131) to use, e.g., a receiver to, e.g., specifically, receive the one or more respective signals to wake-up the one or more wireless devices 130, e.g., a WUR, and/or e.g., to use wake-up radio,
a respective duration of the time gap respectively supported by the wireless device (131),
a respective first identity of the wireless device (131), and
a second identity of a cell (120) wherein the wireless device (131) is located.

Example 13. The method according to example 12, further comprising:
sending (602) the first indication indicating the respective capability of the wireless device (131) to use the receiver to, e.g., specifically, receive the one or more respective signals to wake-up the one or more wireless devices 130, e.g., a WUR supporting one time gap or a plurality of time gaps.

Example 14. The method according to any of examples 10-13, further comprising:
receiving (603) an indication from a node (101) operating in the wireless communications network (100), the indication respectively indicating a result of the determined respective duration of the time gap.

Example 15. The method according to any of examples 10-14, wherein the receiving (607) of the of the respective signal is based on at least one of:
i. the wireless device (131) respectively supporting reception using a receiver to, e.g., specifically, receive the one or more respective signals to wake-up the one or more wireless devices 130, e.g., a WUR or Wake-up receiver,
ii. a receiver to, e.g., specifically, receive the one or more respective signals to wake-up the one or more wireless devices 130, e.g., a WUR, and/or e.g., wake-up radio being supported in a cell (120) wherein the wireless device (131) is located, e.g., at the time of the determining (605), and
iii. a first configuration of the wireless device (131) for the receiver, e.g., WUR, matching a second configuration for the receiver, e.g., WUR, at the cell (120).

Example 16. The method according to any of examples 10-15, further comprising at least one of:
determining (604) which respective paging frame or paging occasion to use, out of a plurality of paging frames or paging occasions, and wherein the determining (605) of the respective duration of the time gap is respectively based on the determined respective paging frame or paging occasion, and
determining (606), based on the determined respective duration of the time gap, a respective at least one of: search space, and random access occasion.

Example 17. The method according to example 13, wherein the determining (605) of the respective duration of the time gap is based on a correspondence between the respective capability of the wireless device (131) and the respective duration of the time gap, and wherein the method further comprises:
receiving (601) a respective previous indication from the node (101), the respective previous indication indicating the correspondence.

Example 18. The method according to any of examples 10-17, wherein the node (101) is one of: a network node (110), a core network node (125), and another wireless device (132).

### Further Extensions And Variations

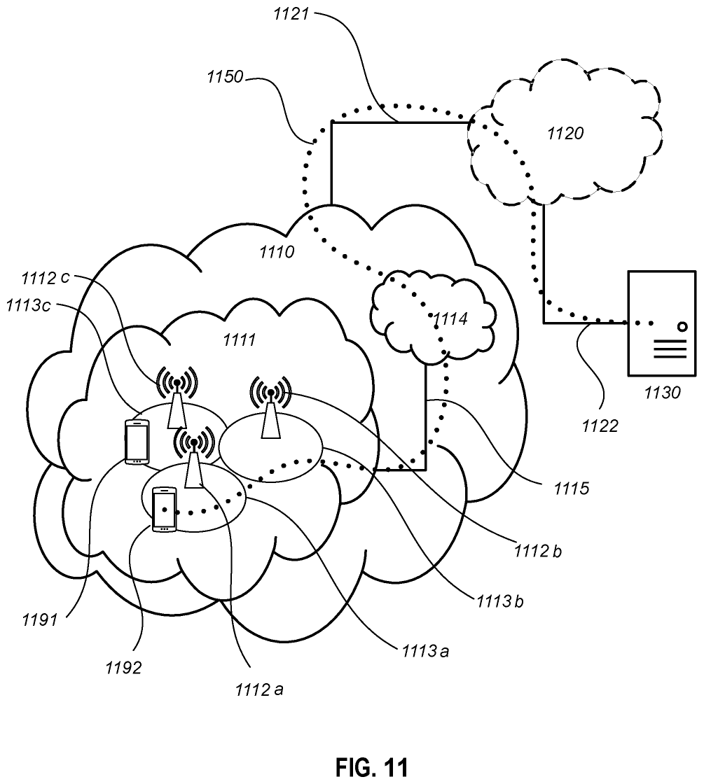

### FIG. 11: Telecommunication Network Connected Via an Intermediate Network to a Host Computer in Accordance with Some Embodiments

With reference to FIG. 11, in accordance with an embodiment, a communication system includes telecommunication network 1110 such as the wireless communications network 100, for example, a 3GPP-type cellular network, which comprises access network 1111, such as a radio access network, and core network 1114. Access network 1111 comprises a plurality of network nodes such as the network node 110. For example, base stations 1112a, 1112b, 1112c, such as NBs, eNBs, gNBs or other types of wireless access points, each defining a corresponding coverage area 1113a, 1113b, 1113c. Each base station 1112a, 1112b, 1112c is connectable to core network 1114 over a wired or wireless connection 1115. A plurality of wireless devices, such as any of the another wireless device 132, or any of the one or more wireless devices, e.g., the wireless device 131 are comprised in the wireless communications network 100. In FIG. 11, a first UE 1191 located in coverage area 1113c is configured to wirelessly connect to, or be paged by, the corresponding base station 1112c. A second UE 1192 in coverage area 1113a is wirelessly connectable to the corresponding base station 1112a. While a plurality of UEs 1191, 1192 are illustrated in this example, the disclosed embodiments are equally applicable to a situation where a sole UE is in the coverage area or where a sole UE is connecting to the corresponding base station 1112. Any of the UEs 1191, 1192 are examples of any of the another wireless device 132, or any of the one or more wireless devices, e.g., the wireless device 131.

Telecommunication network 1110 is itself connected to host computer 1130, which may be embodied in the hardware and/or software of a standalone server, a cloud-implemented server, a distributed server or as processing resources in a server farm. Host computer 1130 may be under the ownership or control of a service provider, or may be operated by the service provider or on behalf of the service provider. Connections 1121 and 1122 between telecommunication network 1110 and host computer 1130 may extend directly from core network 1114 to host computer 1130 or may go via an optional intermediate network 1120. Intermediate network 1120 may be one of, or a combination of more than one of, a public, private or hosted network; intermediate network 1120, if any, may be a backbone network or the Internet; in particular, intermediate network 1120 may comprise two or more sub-networks (not shown).

The communication system of FIG. 11 as a whole enables connectivity between the connected UEs 1191, 1192 and host computer 1130. The connectivity may be described as an over-the-top (OTT) connection 1150. Host computer 1130 and the connected UEs 1191, 1192 are configured to communicate data and/or signaling via OTT connection 1150, using access network 1111, core network 1114, any intermediate network 1120 and possible further infrastructure (not shown) as intermediaries. OTT connection 1150 may be transparent in the sense that the participating communication devices through which OTT connection 1150 passes are unaware of routing of uplink and downlink communications. For example, base station 1112 may not or need not be informed about the past routing of an incoming downlink communication with data originating from host computer 1130 to be forwarded (e.g., handed over) to a connected UE 1191. Similarly, base station 1112 need not be aware of the future routing of an outgoing uplink communication originating from the UE 1191 towards the host computer 1130.

In relation to FIGS. 12, 13, 14, 15, and 16, which are described next, it may be understood that a UE is an example of any of the another wireless device 132, or any of the one or more wireless devices, e.g., the wireless device 131, and that any description provided for the UE equally applies to any of the another wireless device 132, or any of the one or more wireless devices, e.g., the wireless device 131. It may be also understood that the base station is an example of the network node 110, and that any description provided for the base station equally applies to the network node 110.

### FIG. 12: Host Computer Communicating Via a Base Station with a User Equipment Over a Partially Wireless Connection in Accordance with Some Embodiments

Example implementations, in accordance with an embodiment, of any of the another wireless device 132, or any of the one or more wireless devices, e.g., the wireless device 131, e.g., a UE, the network node 110, e.g., a base station and host computer discussed in the preceding paragraphs will now be described with reference to FIG. 12. In communication system 1200, such as the wireless communications network 100, host computer 1210 comprises hardware 1215 including communication interface 1216 configured to set up and maintain a wired or wireless connection with an interface of a different communication device of communication system 1200. Host computer 1210 further comprises processing circuitry 1218, which may have storage and/or processing capabilities. In particular, processing circuitry 1218 may comprise one or more programmable processors, application-specific integrated circuits, field programmable gate arrays or combinations of these (not shown) adapted to execute instructions. Host computer 1210 further comprises software 1211, which is stored in or accessible by host computer 1210 and executable by processing circuitry 1218. Software 1211 includes host application 1212. Host application 1212 may be operable to provide a service to a remote user, such as UE 1230 connecting via OTT connection 1250 terminating at UE 1230 and host computer 1210. In providing the service to the remote user, host application 1212 may provide user data which is transmitted using OTT connection 1250.

Communication system 1200 further includes the network node 110, exemplified in FIG. 12 as a base station 1220 provided in a telecommunication system and comprising hardware 1225 enabling it to communicate with host computer 1210 and with UE 1230. Hardware 1225 may include communication interface 1226 for setting up and maintaining a wired or wireless connection with an interface of a different communication device of communication system 1200, as well as radio interface 1227 for setting up and maintaining at least wireless connection 1270 with any of the another wireless device 132, or any of the one or more wireless devices, e.g., the wireless device 131, exemplified in FIG. 12 as a UE 1230 located in a coverage area (not shown in FIG. 12) served by base station 1220. Communication interface 1226 may be configured to facilitate connection 1260 to host computer 1210. Connection 1260 may be direct or it may pass through a core network (not shown in FIG. 12) of the telecommunication system and/or through one or more intermediate networks outside the telecommunication system. In the embodiment shown, hardware 1225 of base station 1220 further includes processing circuitry 1228, which may comprise one or more programmable processors, application-specific integrated circuits, field programmable gate arrays or combinations of these (not shown) adapted to execute instructions. Base station 1220 further has software 1221 stored internally or accessible via an external connection.

Communication system 1200 further includes UE 1230 already referred to. Its hardware 1235 may include radio interface 1237 configured to set up and maintain wireless connection 1270 with a base station serving a coverage area in which UE 1230 is currently located. Hardware 1235 of UE 1230 further includes processing circuitry 1238, which may comprise one or more programmable processors, application-specific integrated circuits, field programmable gate arrays or combinations of these (not shown) adapted to execute instructions. UE 1230 further comprises software 1231, which is stored in or accessible by UE 1230 and executable by processing circuitry 1238. Software 1231 includes client application 1232. Client application 1232 may be operable to provide a service to a human or non-human user via UE 1230, with the support of host computer 1210. In host computer 1210, an executing host application 1212 may communicate with the executing client application 1232 via OTT connection 1250 terminating at UE 1230 and host computer 1210. In providing the service to the user, client application 1232 may receive request data from host application 1212 and provide user data in response to the request data. OTT connection 1250 may transfer both the request data and the user data. Client application 1232 may interact with the user to generate the user data that it provides.

It is noted that host computer 1210, base station 1220 and UE 1230 illustrated in FIG. 12 may be similar or identical to host computer 1130, one of base stations 1112a, 1112b, 1112c and one of UEs 1191, 1192 of FIG. 11, respectively. This is to say, the inner workings of these entities may be as shown in FIG. 12 and independently, the surrounding network topology may be that of FIG. 11.

In FIG. 12, OTT connection 1250 has been drawn abstractly to illustrate the communication between host computer 1210 and UE 1230 via base station 1220, without explicit reference to any intermediary devices and the precise routing of messages via these devices. Network infrastructure may determine the routing, which it may be configured to hide from UE 1230 or from the service provider operating host computer 1210, or both. While OTT connection 1250 is active, the network infrastructure may further take decisions by which it dynamically changes the routing (e.g., on the basis of load balancing consideration or reconfiguration of the network).

Wireless connection 1270 between UE 1230 and base station 1220 is in accordance with the teachings of the embodiments described throughout this disclosure. One or more of the various embodiments improve the performance of OTT services provided to UE 1230 using OTT connection 1250, in which wireless connection 1270 forms the last segment. More precisely, the teachings of these embodiments may improve the latency, signalling overhead, and service interruption and thereby provide benefits such as reduced user waiting time, better responsiveness and extended battery lifetime.

A measurement procedure may be provided for the purpose of monitoring data rate, latency and other factors on which the one or more embodiments improve. There may further be an optional network functionality for reconfiguring OTT connection 1250 between host computer 1210 and UE 1230, in response to variations in the measurement results. The measurement procedure and/or the network functionality for reconfiguring OTT connection 1250 may be implemented in software 1211 and hardware 1215 of host computer 1210 or in software 1231 and hardware 1235 of UE 1230, or both. In embodiments, sensors (not shown) may be deployed in or in association with communication devices through which OTT connection 1250 passes; the sensors may participate in the measurement procedure by supplying values of the monitored quantities exemplified above, or supplying values of other physical quantities from which software 1211, 1231 may compute or estimate the monitored quantities. The reconfiguring of OTT connection 1250 may include message format, retransmission settings, preferred routing etc.; the reconfiguring need not affect base station 1220, and it may be unknown or imperceptible to base station 1220. Such procedures and functionalities may be known and practiced in the art. In certain embodiments, measurements may involve proprietary UE signaling facilitating host computer 1210's measurements of throughput, propagation times, latency and the like. The measurements may be implemented in that software 1211 and 1231 causes messages to be transmitted, in particular empty or ‘dummy’ messages, using OTT connection 1250 while it monitors propagation times, errors etc.

The node 101 embodiments relate to FIG. 5, FIG. 7, FIG. 8, FIG. 9 and FIGS. 11-16.

The node 101 may also be configured to communicate user data with a host application unit in a host computer 1210, e.g., via another link such as 1260.

The node 101 may comprise an interface unit to facilitate communications between the node 101 and other nodes or devices, e.g., the one or more wireless device 130, the wireless device 131, the network node 110, the host computer 1210, or any of the other nodes. In some particular examples, the interface may, for example, include a transceiver configured to transmit and receive radio signals over an air interface in accordance with a suitable standard.

The node 101 may comprise an arrangement as shown in FIG. 9 or in FIG. 12.

The wireless device 131 embodiments relate to FIG. 6, FIG. 7, FIG. 8, FIG. 10 and FIGS. 11-16.

The wireless device 131 may also be configured to communicate user data with a host application unit in a host computer 1210, e.g., via another link such as 1260.

The wireless device 131 may comprise an interface unit to facilitate communications between the wireless device 131 and other nodes or devices, e.g., the node 101, the network node 110, the core network node 125, the another wireless device 132, any of the other one or more wireless devices 130, the host computer 1210, or any of the other nodes. In some particular examples, the interface may, for example, include a transceiver configured to transmit and receive radio signals over an air interface in accordance with a suitable standard.

The wireless device 131 may comprise an arrangement as shown in FIG. 10 or in FIG. 12.

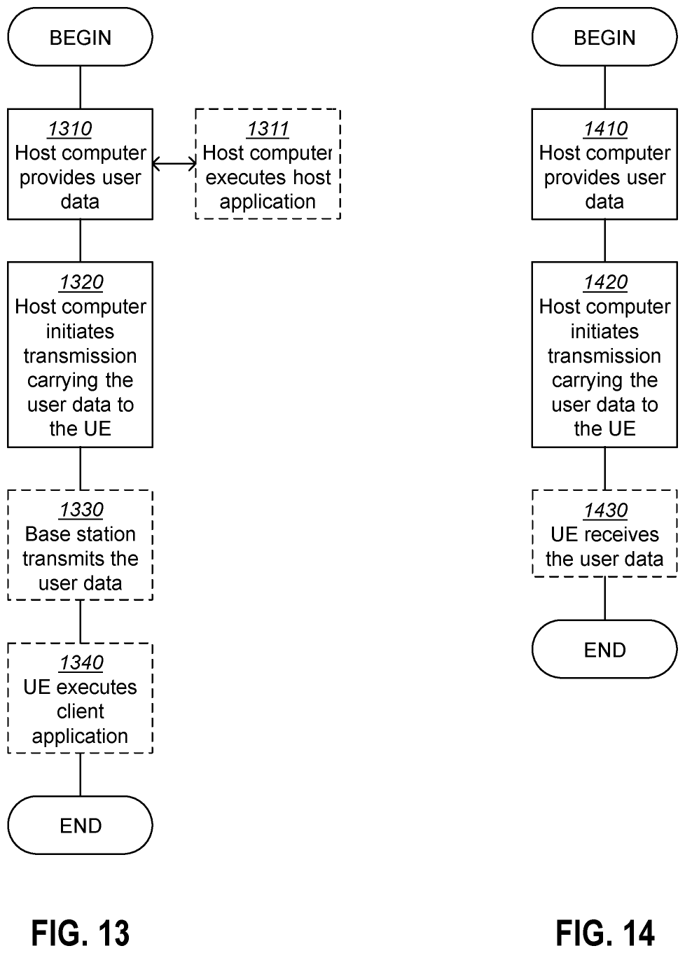

### FIG. 13: Methods Implemented in a Communication System Including a Host Computer, a Base Station and a User Equipment in Accordance with Some Embodiments

FIG. 13 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 13 will be included in this section. In step 1310, the host computer provides user data. In substep 1311 (which may be optional) of step 1310, the host computer provides the user data by executing a host application. In step 1320, the host computer initiates a transmission carrying the user data to the UE. In step 1330 (which may be optional), the base station transmits to the UE the user data which was carried in the transmission that the host computer initiated, in accordance with the teachings of the embodiments described throughout this disclosure. In step 1340 (which may also be optional), the UE executes a client application associated with the host application executed by the host computer.

### FIG. 14: Methods Implemented in a Communication System Including a Host Computer, a Base Station and a User Equipment in Accordance with Some Embodiments

FIG. 14 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 14 will be included in this section. In step 1410 of the method, the host computer provides user data. In an optional substep (not shown) the host computer provides the user data by executing a host application. In step 1420, the host computer initiates a transmission carrying the user data to the UE. The transmission may pass via the base station, in accordance with the teachings of the embodiments described throughout this disclosure. In step 1430 (which may be optional), the UE receives the user data carried in the transmission.

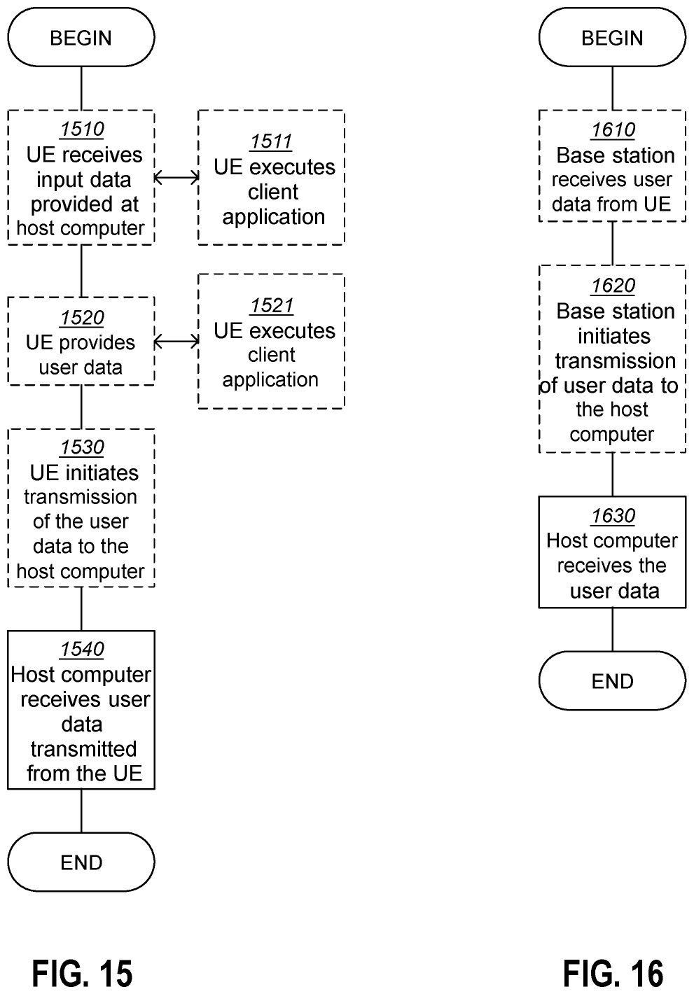

### FIG. 15: Methods Implemented in a Communication System Including a Host Computer, a Base Station and a User Equipment in Accordance with Some Embodiments

FIG. 15 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 15 will be included in this section. In step 1510 (which may be optional), the UE receives input data provided by the host computer. Additionally or alternatively, in step 1520, the UE provides user data. In substep 1521 (which may be optional) of step 1520, the UE provides the user data by executing a client application. In substep 1511 (which may be optional) of step 1510, the UE executes a client application which provides the user data in reaction to the received input data provided by the host computer. In providing the user data, the executed client application may further consider user input received from the user. Regardless of the specific manner in which the user data was provided, the UE initiates, in substep 1530 (which may be optional), transmission of the user data to the host computer. In step 1540 of the method, the host computer receives the user data transmitted from the UE, in accordance with the teachings of the embodiments described throughout this disclosure.

### FIG. 16: Methods Implemented in a Communication System Including a Host Computer, a Base Station and a User Equipment in Accordance with Some Embodiments

FIG. 16 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 16 will be included in this section. In step 1610 (which may be optional), in accordance with the teachings of the embodiments described throughout this disclosure, the base station receives user data from the UE. In step 1620 (which may be optional), the base station initiates transmission of the received user data to the host computer. In step 1630 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### Further Numbered Embodiments

1. A base station configured to communicate with a user equipment (UE), the base station comprising a radio interface and processing circuitry configured to perform one or more of the actions described herein as performed by the network node 110.
5. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform one or more of the actions described herein as performed by the network node 110.
   6. The communication system of embodiment 5, further including the base station.
   7. The communication system of embodiment 6, further including the UE, wherein the UE is configured to communicate with the base station.
   8. The communication system of embodiment 7, wherein:
the processing circuitry of the host computer is configured to execute a host application, thereby providing the user data; and
the UE comprises processing circuitry configured to execute a client application associated with the host application.
   11. A method implemented in a base station, comprising one or more of the actions described herein as performed by the network node 110.
   15. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs one or more of the actions described herein as performed by the network node 110.
   16. The method of embodiment 15, further comprising:
at the base station, transmitting the user data.
   17. The method of embodiment 16, wherein the user data is provided at the host computer by executing a host application, the method further comprising:
at the UE, executing a client application associated with the host application.
   21. A user equipment (UE) configured to communicate with a base station, the UE comprising a radio interface and processing circuitry configured to perform one or more of the actions described herein as performed by any of the another wireless device 132, or any of the one or more wireless devices, e.g., the wireless device 131.
   25. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's processing circuitry configured to perform one or more of the actions described herein as performed by any of the another wireless device 132, or any of the one or more wireless devices, e.g., the wireless device 131.
   26. The communication system of embodiment 25, further including the UE.
   27. The communication system of embodiment 26, wherein the cellular network further includes a base station configured to communicate with the UE.
   28. The communication system of embodiment 26 or 27, wherein:
the processing circuitry of the host computer is configured to execute a host application, thereby providing the user data; and
the UE's processing circuitry is configured to execute a client application associated with the host application.
   31. A method implemented in a user equipment (UE), comprising one or more of the actions described herein as performed by any of the another wireless device 132, or any of the one or more wireless devices, e.g., the wireless device 131.
   35. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs one or more of the actions described herein as performed by any of the another wireless device 132, or any of the one or more wireless devices, e.g., the wireless device 131.
   36. The method of embodiment 35, further comprising:
at the UE, receiving the user data from the base station.
   41. A user equipment (UE) configured to communicate with a base station, the UE comprising a radio interface and processing circuitry configured to perform one or more of the actions described herein as performed by any of the another wireless device 132, or any of the one or more wireless devices, e.g., the wireless device 131.
   45. A communication system including a host computer comprising:
a communication interface configured to receive user data originating from a transmission from a user equipment (UE) to a base station,
wherein the UE comprises a radio interface and processing circuitry, the UE's processing circuitry configured to: perform one or more of the actions described herein as performed by any of the another wireless device 132, or any of the one or more wireless devices, e.g., the wireless device 131.
   46. The communication system of embodiment 45, further including the UE.
   47. The communication system of embodiment 46, further including the base station, wherein the base station comprises a radio interface configured to communicate with the UE and a communication interface configured to forward to the host computer the user data carried by a transmission from the UE to the base station.
   48. The communication system of embodiment 46 or 47, wherein:
the processing circuitry of the host computer is configured to execute a host application; and
the UE's processing circuitry is configured to execute a client application associated with the host application, thereby providing the user data.
   49. The communication system of embodiment 46 or 47, wherein:
the processing circuitry of the host computer is configured to execute a host application, thereby providing request data; and
the UE's processing circuitry is configured to execute a client application associated with the host application, thereby providing the user data in response to the request data.
   51. A method implemented in a user equipment (UE), comprising one or more of the actions described herein as performed by any of the another wireless device 132, or any of the one or more wireless devices, e.g., the wireless device 131.
   52. The method of embodiment 51, further comprising:
providing user data; and
forwarding the user data to a host computer via the transmission to the base station.
   55. A method implemented in a communication system including a host computer, a base station and a user equipment (UE), the method comprising:
at the host computer, receiving user data transmitted to the base station from the UE, wherein the UE performs one or more of the actions described herein as performed by any of the another wireless device 132, or any of the one or more wireless devices, e.g., the wireless device 131.
   56. The method of embodiment 55, further comprising:
at the UE, providing the user data to the base station.
   57. The method of embodiment 56, further comprising:
at the UE, executing a client application, thereby providing the user data to be transmitted; and
at the host computer, executing a host application associated with the client application.
   58. The method of embodiment 56, further comprising:
at the UE, executing a client application; and
at the UE, receiving input data to the client application, the input data being provided at the host computer by executing a host application associated with the client application,
wherein the user data to be transmitted is provided by the client application in response to the input data.
   61. A base station configured to communicate with a user equipment (UE), the base station comprising a radio interface and processing circuitry configured to perform one or more of the actions described herein as performed by the network node 110.
   65. A communication system including a host computer comprising a communication interface configured to receive user data originating from a transmission from a user equipment (UE) to a base station, wherein the base station comprises a radio interface and processing circuitry, the base station's processing circuitry configured to perform one or more of the actions described herein as performed by the network node 110.
   66. The communication system of embodiment 65, further including the base station.
   67. The communication system of embodiment 66, further including the UE, wherein the UE is configured to communicate with the base station.
   68. The communication system of embodiment 67, wherein:
the processing circuitry of the host computer is configured to execute a host application;
the UE is configured to execute a client application associated with the host application, thereby providing the user data to be received by the host computer.
   71. A method implemented in a base station, comprising one or more of the actions described herein as performed by the network node 110.
   75. A method implemented in a communication system including a host computer, a base station and a user equipment (UE), the method comprising:
at the host computer, receiving, from the base station, user data originating from a transmission which the base station has received from the UE, wherein the UE performs one or more of the actions described herein as performed by any of the another wireless device 132, or any of the one or more wireless devices, e.g., the wireless device 131.
   76. The method of embodiment 75, further comprising:
at the base station, receiving the user data from the UE.
   77. The method of embodiment 76, further comprising:
at the base station, initiating a transmission of the received user data to the host computer.

1. A method performed by a node, the method being for handling a time gap, the node operating in a wireless communications network, the method comprising:
determining a respective duration of a time gap between a transmission of one or more respective signals to wake-up one or more wireless devices operating in the wireless communications network and a beginning of one or more respective paging occasions, the determining being based on a condition, the condition being independent of whether or not the one or more wireless devices use discontinuous reception or extended discontinuous reception; and
initiating transmission of the one or more respective signals to the one or more wireless devices based on the determined respective duration.

2. The method according to claim 1, wherein the condition is one of:
a respective type of the one or more wireless devices;
a first indication indicating a respective capability of the one or more wireless devices to use a receiver to receive the one or more respective signals to wake-up the one or more wireless devices;
a respective duration of the time gap respectively supported by the one or more wireless devices;
a respective first identity of the one or more wireless devices; and
a second identity of a cell wherein the one or more wireless devices are respectively located.

3. The method according to claim 2, further comprising:
obtaining the first indication indicating the respective capability of the one or more wireless devices to use the receiver to receive the one or more respective signals to wake-up the one or more wireless devices, supporting one time gap or a plurality of time gaps.

4. The method according to claim 1, further comprising:
sending one or more indications towards the one or more wireless devices, the one or more indications respectively indicating a result of the determined respective duration of the time gap.

5. The method according to claim 1,
wherein the initiating of the transmission of the one or more respective signals to the one or more wireless devices is based on at least one of:
the one or more wireless devices respectively supporting reception using a receiver to receive the one or more respective signals to wake-up the one or more wireless devices;
WUR being supported in a cell wherein the one or more wireless devices are respectively located; and
a first configuration of a respective wireless device for the receiver to receive the one or more respective signals to wake-up the one or more wireless devices, matching a second configuration for the receiver at the cell.

6. The method according to claim 1, further comprising at least one of:
determining which respective paging frame or paging occasion to use for the one or more wireless devices, out of a plurality of paging frames or paging occasions, and wherein the determining of the respective duration of the time gap is respectively based on the determined respective paging frame or paging occasion; and
determining, based on the determined respective duration of the time gap, a respective at least one of: search space, and random access occasion.

7. The method according to claim 3, wherein the determining of the respective duration of the time gap is based on a correspondence between the respective capability of the one or more wireless devices and the respective duration of the time gap, and wherein the method further comprises:
sending a respective previous indication to the one or more wireless devices, the respective previous indication indicating the correspondence.

8. The method according to claim 1, wherein the node is one of: a network node, a core network node, and another wireless device.

9. A method performed by a wireless device, the method being for handling a time gap, the wireless device operating in a wireless communications network, the method comprising:
determining a respective duration of a time gap between a transmission of a respective signal to wake-up the wireless device, and a beginning of a respective paging occasion for the wireless device, the determining being based on a condition, the condition being independent of whether or not the wireless device uses discontinuous reception or extended discontinuous reception; and
receiving the respective signal based on the determined respective duration.

10. The method according to claim 9, wherein the condition is one of:
a respective type of the wireless device,
a first indication indicating a respective capability of the wireless device to use a receiver to receive the one or more respective signals to wake-up the one or more wireless devices;
a respective duration of the time gap respectively supported by the wireless device;
a respective first identity of the wireless device; and
a second identity of a cell wherein the wireless device is located.

11. The method according to claim 10, further comprising:
sending the first indication indicating the respective capability of the wireless device to use the receiver to receive the one or more respective signals to wake-up the one or more wireless devices, supporting one time gap or a plurality of time gaps.

12. The method according to claim 9, further comprising:
receiving an indication from a node operating in the wireless communications network, the indication respectively indicating a result of the determined respective duration of the time gap.

13. The method according to claim 9, wherein the receiving of the of the respective signal is based on at least one of:
the wireless device respectively supporting reception using a receiver to receive the respective signal to wake-up the wireless device;
a receiver to receive the respective signal to wake-up the wireless device 134 being supported in a cell wherein the wireless device is located; and
a first configuration of the wireless device for the receiver matching a second configuration for the receiver at the cell.

14. The method according to claim 9, further comprising at least one of:
determining which respective paging frame or paging occasion to use, out of a plurality of paging frames or paging occasions, and wherein the determining of the respective duration of the time gap is respectively based on the determined respective paging frame or paging occasion; and
determining, based on the determined respective duration of the time gap, a respective at least one of: search space, and random access occasion.

15. The method according to claim 11, wherein the determining of the respective duration of the time gap is based on a correspondence between the respective capability of the wireless device and the respective duration of the time gap, and wherein the method further comprises:
receiving a respective previous indication from the node, the respective previous indication indicating the correspondence.

16. The method according to claim 9, wherein the node is one of: a network node, a core network node, and another wireless device.

17. A node, for handling a time gap, the node being configured to operate in a wireless communications network, and the node being further configured to:
determine a respective duration of a time gap between a transmission of one or more respective signals to wake-up one or more wireless devices configured to operate in the wireless communications network and a beginning of one or more respective paging occasions, the determining being configured to be based on a condition, the condition being configured to be independent of whether or not the one or more wireless devices are configured to use discontinuous reception or extended discontinuous reception; and
initiate transmission of the one or more respective signals to the one or more wireless devices based on the respective duration configured to be determined.

18. The node according to claim 17, wherein the condition is configured to be one of:
a respective type of the one or more wireless devices;
a first indication configured to indicate a respective capability of the one or more wireless devices to use a receiver to receive the one or more respective signals to wake-up the one or more wireless devices;
a respective duration of the time gap configured to be respectively supported by the one or more wireless devices;
a respective first identity of the one or more wireless devices; and
a second identity of a cell wherein the one or more wireless devices are configured to be respectively located.

19. The node according to claim 18, being further configured to:
obtain the first indication configured to indicate the respective capability of the one or more wireless devices to use the receiver to receive the one or more respective signals to wake-up the one or more wireless devices, supporting one time gap or a plurality of time gaps.

20.-24. (canceled)

25. A wireless device, for handling a time gap, the wireless device being configured to operate in a wireless communications network, the wireless device being further configured to:
determine a respective duration of a time gap between a transmission of a respective signal to wake-up the wireless device, and a beginning of a respective paging occasion for the wireless device, the determining being configured to be based on a condition, the condition being configured to be independent of whether or not the wireless device uses discontinuous reception or extended discontinuous reception; and
receive the respective signal based on the respective duration configured to be determined.

26.-32. (canceled)
